(19) United States
(12) Patent Application Publication
(10) Pub. No.: US 2014/0164476 A1
(43) Pub. Date: Jun. 12, 2014

(54) APPARATUS AND METHOD FOR PROVIDING A VIRTUAL ASSISTANT

(71) Applicant: AT&T INTELLECTUAL PROPERTY I, L.P., Atlanta, GA (US)

(72) Inventor: David Thomson, Madison, NJ (US)

(73) Assignee: AT&T INTELLECTUAL PROPERTY I, LP, Atlanta, GA (US)

(21) Appl. No.: 13/706,382

(22) Filed: Dec. 6, 2012

(51) Int. Cl. H04L 29/06

(52) U.S. Cl. CPC H04L 67/42
USPC 709/203

(57) ABSTRACT

A system that incorporates the subject disclosure may include, for example, receiving an information request from an end user device, obtaining feedback information associated with a group of content service modules where the feedback information includes accuracy ratings for data provided by the group of content service modules responsive to past information requests of other communication sessions, selecting a subset of content service modules from among the group of content service modules based on the feedback information, receiving a group of responses from the subset of content service modules responsive to the invite messages by way of the application programming interface, and selecting a subset of responses from among the group of responses based on the feedback information. Other embodiments are disclosed.

### FIELD OF THE DISCLOSURE

The subject disclosure relates to an apparatus and method for providing a virtual assistant.

### BACKGROUND

A virtual assistant is software that can receive a request for information and can provide the information in response to the request. One obstacle to creating a virtual assistant is the specialized skill and specific resources required to build various features for the virtual assistant. For instance, a navigation service may require map information and the technology to efficiently plot a course, while a travel booking service may require a business relationship with airlines and hotels. Developing the broad range of skills and resources can be difficult for an entity trying to create the virtual assistant.

### BRIEF DESCRIPTION OF THE DRAWINGS

Reference will now be made to the accompanying drawings, which are not necessarily drawn to scale, and wherein:

FIGS. 1-2 depict illustrative embodiments of a system for providing a virtual assistant accessible through an end user device;

FIGS. 3A and 3B depict illustrative embodiments of a method used in portions of the system described in FIGS. 1-2;

FIG. 4 depicts an illustrative embodiment of a display presented by the end user device of the system of FIGS. 1-2;

FIGS. 5-7 depict illustrative embodiments of a system for providing a virtual assistant accessible through an end user device;

FIG. 8 depicts an illustrative embodiment of a web portal for interacting with the communication systems of FIGS. 1-2 and 4-7;

FIG. 9 depicts an illustrative embodiment of a communication device that can provide virtual assistant services; and

FIG. 10 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments of a system that provides virtual assistant services based on directing user requests to a farm of software experts (e.g., content service modules), which can be written by various developers that are related or unrelated. In one or more embodiments, multiple experts embodied in software and/or hardware may respond to each user request, and the system can include a process for selecting the best or desired response, such as based in whole or in part on user feedback. One or more of the exemplary embodiments can permit entities to focus limited resources on writing software code for software experts in areas where they have the greatest expertise. One or more of the exemplary embodiments can provide a published. Application Programming Interface (API) that enables developers to integrate their software experts without custom development and without complex business relationships between companies.

One or more of the exemplary embodiments can enable collecting of personal assistant data by recruiting various companies to write specific functions for a body of software. For instance, a sponsor can write a master dialog manager that provides a recognizable string to a community of software modules (experts). The dialog manager can select the software experts that provide the best or desired output based in whole or in part on feedback from users. A virtual assistant can be launched which is implemented via the software experts and the sponsor can collect usage data.

One or more of the embodiments can provide the virtual assistant as a distributed process including an end user device, a dialog manager, a speech recognizer, a collection of software experts (e.g., residing on expert devices) written by a community of developers or vendors, and a bid selector that can choose the output of one or more software experts based on various criteria including user ratings and other factors. Experts may compete against each other for user ratings. In one embodiment, outputs of those software experts with the highest ratings can be presented to the user. Other embodiments are included in the subject disclosure.

One embodiment of the subject disclosure includes a server that has a memory to store instructions and a processor coupled to the memory. The processor, responsive to executing the instructions, performs operations including receiving an information request via a communication session from an end user device where the information request is generated at the end user device. The processor can determine subject matter associated with the information request and identify a group of content service modules from among a plurality of content service modules according to the subject matter. The processor can obtain session metadata associated with the end user device and associated with the group of content service modules where the session metadata includes user preferences of the end user device and a monitored response history of the group of content service modules. The processor can select a subset of content service modules from among the group of content service modules based on the session metadata. The processor can provide invite messages to the subset of content service modules by way of an application programming interface where the invite messages are indicative of the information request. The processor can receive a group of responses from the subset of content service modules responsive to the invite messages by way of the application programming interface. The processor can obtain feedback information associated with the subset of content service modules, where the feedback information includes accuracy ratings for past responses provided by the subset of content service modules in response to past information requests of other communication sessions. The processor can select a subset of responses from among the group of responses based on the feedback information.

One embodiment of the subject disclosure includes a method where any number of the steps can be performed by a system that includes any number of processors. The method can include receiving an information request via a communication session from an end user device where the information request is generated at the end user device. The method can include obtaining feedback information associated with a group of content service modules, where the feedback information includes accuracy ratings for past responses provided by the group of content service modules responsive to past information requests of other communication sessions. The method can include selecting a subset of content service modules from among the group of content service modules based on the feedback information. The method can include providing invite messages to the subset of content service modules by way of an application programming interface, where the invite messages are indicative of the information request. The method can include receiving a group of responses from the subset of content service modules responsive to the invite messages by way of the application programming interface. The method can include selecting a subset of responses from among the group of responses based on the feedback information.

One embodiment of the subject disclosure includes a computer-readable storage device, comprising computer instructions which, responsive to being executed by a processor of an end user device, cause the processor to perform operations including generating an information request based on user input. The computer instructions can include providing the information request via a communication session to a server to cause the server to obtain a subset of responses selected from among a group of responses to the information request, where the group of responses are generated by a subset of content service modules selected from among a group of content service modules based on feedback information that includes accuracy ratings for past responses provided by the group of content service modules in response to past information requests of other communication sessions. The computer instructions can include receiving the subset of responses from the server and presenting the subset of responses. The computer instructions can include generating user feedback based on additional user input, where the user feedback is associated with the presenting of the subset of responses. The computer instructions can include providing the user feedback to the server to cause the server to adjust the feedback information based on the user feedback.

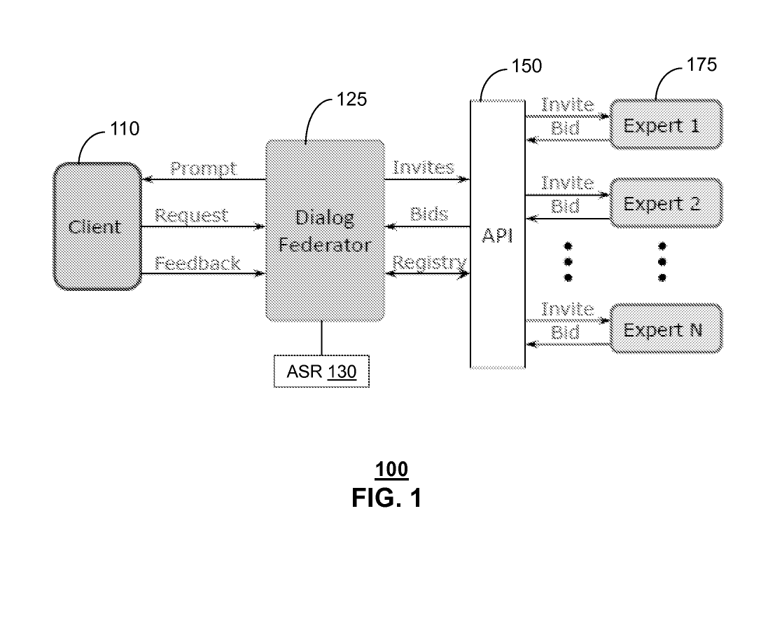

Referring generally to FIG. 1, an example system 100 is illustrated that includes a client 110, a dialog federator 125, an Application Programming Interface (API) 150 and one or more experts 175. The client 110, the dialog federator 125, the API 150 and/or the experts 175 can be software and/or hardware resident on and/or integrated with separate computing devices and/or combined (e.g., partially) to be resident on (and/or integrated with) a fewer number of computing devices (e.g., the client 110 and the dialog federator 125 being resident on an end user device while the API 150 and each of the experts are resident on separate servers). Various configurations of the client 110, the dialog federator 125, the API 150 and the experts 175 separated or combined on computing device(s) can be included in the exemplary embodiments. As an example, the experts 175 can be content service modules (e.g., software and/or hardware that can respond to requests by obtaining responses which can include media content) that provide responses to various information requests generated via the client 110 which is resident at an end user device.

In one or more embodiments, the client 110 can be a module (e.g., software and/or hardware) residing on an end user device, such as a smartphone, personal computer, set top box, appliance, or other device. A user can issue a request, such as by voice, text and/or physical gesture (e.g., captured via image), and the client 110 can send the request to the dialog federator 125, such as via wireless and/or wired communications. In one or more embodiments, if the dialog federator 125 receives audio, the dialog federator may convert the audio to text using an automatic speech recognizer (ASR) 130. In one or more embodiments, if the dialog federator 125 receives images of a physical gesture, the dialog federator may recognize the physical gesture and convert it to a text or other derived representation via image pattern recognition. In one or more embodiments, the image recognition may not reduce to text. A gesture may, for example, consist of a sequence of numerical parameters that represent a hand position. The gesture may also be represented as a vector of symbols that correspond to hand shape, motion, position, etc. In other embodiments, audio-to-text conversion and/or image pattern recognition (and conversion to text) can be performed at the client 110 or another device in communication with the client so that the dialog federator 125 receives a text-based request.

In one or more embodiments, the dialog federator 125 can send the user request (e.g., directly in text format and/or in a format converted by the ASR 130 or by other means) via the API 150 to a number of experts 175. For instance, invites can be sent from the dialog federator 125 to the experts 175 (or some of the experts) via the API 150. Each expert 175 (or a subset of the experts) may respond to the request with an answer (called herein a “bid”) or may choose not to respond. Experts 175 may share registry data (e.g., information about the user, the client 110, the client device, the communication session, and/or monitored communications history) with the dialog federator 125 and/or with each other. The sharing of the registry data can be in whole or in part, such as limiting access to registry data for particular experts 175 that are not authorized to access certain information, such as sharing user-based registry data only with experts that are on a user-approved sharing list.

The dialog federator 125 (e.g., responsive to the bid or bids) can provide a prompt for the client 110. In one or more embodiments, the process for using bids to generate a prompt can be influenced by feedback from the user, such as user ratings on bids provided by experts 175 in the past. A prompt can be in many forms, such as an initial signal for the user to respond and/or an answer or response to one or more previous requests from the user. The terms “prompt” and “answer” herein may be used interchangeably to denote a signal provided to the user by the system 100 that enables access to a virtual assistant.

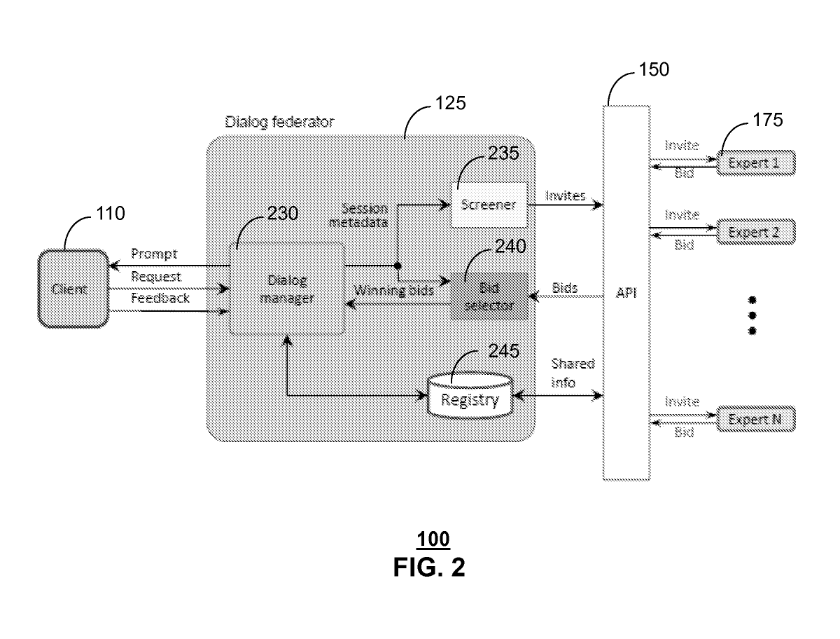

Referring to FIG. 2, system 100 is illustrated in more detail with some of the internal workings of the dialog federator 125 which can include a dialog manager 230, a screener 235, a bid selector 240, and a registry 245. The dialog manager 230 can receive a user request and can generate session or conversation metadata including the state and events for the current session (e.g., human-to-machine dialog) with the user and may include historical information, such as from past sessions. Session metadata may include, for example, audio from the user, the output of a speech recognizer, text from the user, a transcript of the user request, and facts or other information known about the user such as credit history, account balance, usage patterns, and the user's name and phone number.

Session metadata may further include output from elements in the dialog federator 125 and dialog manager 230 such as a speech recognizer, natural language processor, dialog memory, logs, a scorekeeper, experts, and/or the API 150. Session metadata may further include knowledge or other information of the experts 175 and their history, a record of the user and his/her history, user preferences from a user admin page and/or other internal and external data sources.

In one or more embodiments, a screener 235 can select one or more experts 175 using session metadata, including the speech recognizer output, metadata history, and/or ratings of experts. The selected experts 175 can each receive an invite or an indication that the expert may respond to the user's request. For example, the invite may include a subset of the session metadata. In one embodiment, experts 175 can each sign up for topics for which the experts assert to be competent. Examples of topics are shown in table 1 below in the column labeled “Expert topics.” In one or more embodiments, the screener 235 can then input a user request into an intent classifier, which outputs one or more topics or user intents. The screener 235 can determine (e.g., responsive to the output of the intent classifier) which experts 175 have signed up for or are otherwise associated with the output topics and can send an invite to those experts.

As an example, the screener 235 may identify the word “weather” and can send the text form of the user request along with the user's location to a subset of experts 175 deemed likely, based on past behavior and other factors, to respond to weather requests. The selection may be based on positive ratings and an expert's history of responding to requests containing the word “weather.”

Experts 175 that have received an invite may respond with a bid. In one embodiment, a bid can be an offer to provide information to the user and may comprise text, audio, graphics, video and/or other media or content. A bid may comprise an answer to be presented to the user and may further comprise additional information such as confidence of the answer accuracy, offer of payment to the sponsor, and/or formatting specifications for how the answer should appear. In one or more embodiments, the bid may also include execution of a task or an offer, contingent on acceptance from the user, to execute a task, such as making a purchase or downloading content (e.g., a video game). In some cases, more experts 175 may bid than is needed or than is practical to present to the client 110. In such cases, a bid selector 240 may choose one or more bids from among the pool of bidding experts. In one or more embodiments, experts 175 selected by the bid selector 240 can provide one or more answers that are consolidated into a prompt and presented to the user via the client 110.

Both the screener 235 and bid selector 240 may use multiple sources of information in their respective selection processes. These sources may include a history of explicit feedback from users such as clicking a thumbs-up or thumbs-down symbol (or other selectable feedback indicator) or they may include implicit feedback such as responding to the prompt.

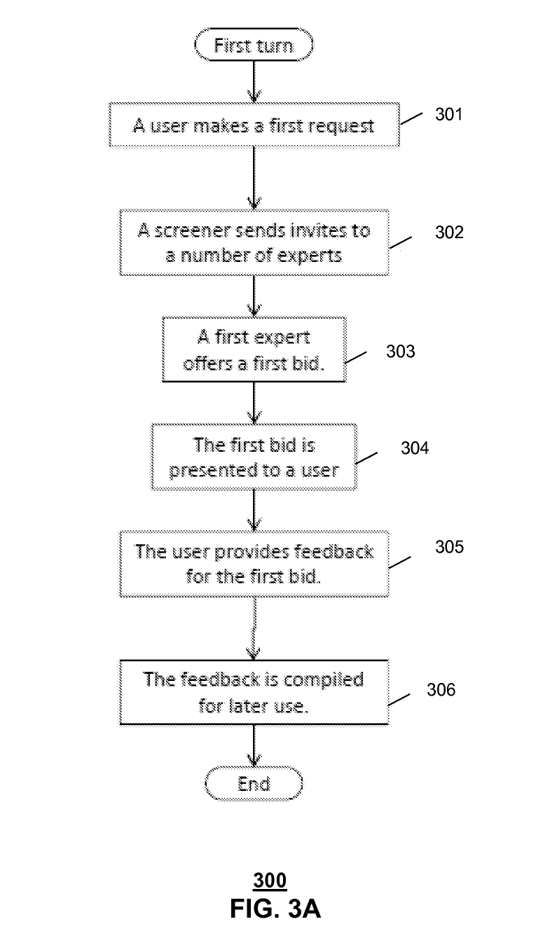

Referring additionally to FIGS. 3A and 3B, a method 300 is illustrated that includes an example dialog or conversation between the user and the virtual assistant. In a first turn, a first user makes a first request at 301 such as via client 110. At 302, a screener 235 can send invites to one or more experts 175. A first expert 175 can offer a bid at 303. The bid can be presented to a user at 304, such as via client 110. At 305, the user can provide feedback (e.g., via client 110) on the quality of the answer derived from the bid. For example, the user may click a “thumbs up” icon or click on the answer for more information. At 306, user feedback can be compiled (e.g., by the dialog federator 125) for use in a second turn, which may be in the current session and/or a future session. This feedback or compiled feedback may be used in the future by the screener 235 or bid selector 240. For example, a positive rating or other interaction with the answer may make it more likely that bids from the same expert will be chosen in the future.

In a second turn, a second user, which may or may not be the same as the first user, makes a second request at 307, such as, “What is the weather forecast?” At 308, the client 110 can record the user's voice sample (or receive other user input indicative of the second request) and can send it to the dialog federator 125, along with other information, such as the user's GPS location. In one or more embodiments at 309, the dialog federator 125 can use the ASR 130 to transcribe the user's utterance. This transcription can be included in the session metadata. At 310, the screener 235 can use metadata such as associated with the user request to select a subset of experts 175 to send an invite.

At 311, experts 175 can compute their answers and offer bids. For example, a first expert 175 may consult a dictionary and answer with a bid consisting of the text string, “A weather forecast is a prediction of weather conditions,” and a second expert 175 may check the national weather service for the user's GPS location and answer, “In Madison, N.J., light rain overnight.” Experts 175 can send their results via the API 150 to the bid selector 240. At 312, the bid selector can select the best answer or answers based on prior feedback, the current answer, and/or other factors. A determination can be made at 313 regarding a more appropriate or better suited bid(s). If the bid selector 240 determines that the first expert's bid is best or more desired, then at 314 it can send the first expert's bid to the user via the client 110. Otherwise, it can provide the second expert's bid to the client 110 at 315. Any number of bids can be evaluated and selected, while any number of bids can be requested and eventually presented at the client 110. The application of the end user device (e.g., a mobile device that is also executing the client 110) can display a message based on the winning bid or bids, such as printing the message, “In Madison, N.J., light rain overnight.” Method 300 is an example that is related to weather related content and involves only two turns. It should be understood that method 300 can apply to any requests/bids, as well as any number of turns during a conversation by the user with the virtual assistant being implemented by method 300. Method 300 is not limited to a single subject matter for the request. For instance, one or more requests can be related to a first subject matter but due to bids being presented to the user can result in a transition to a second (or any other number) of subject matters.

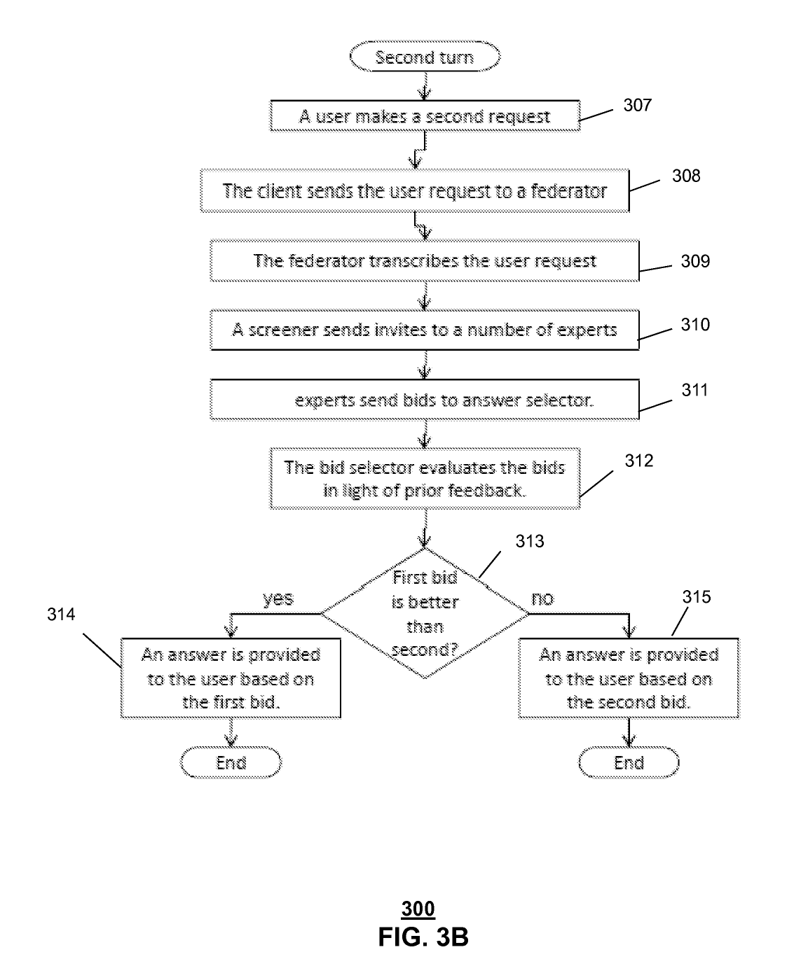

FIG. 4 illustrates an example of a display 400, such as can be presented by client 110 at a mobile device, although the display can be presented at any display device including a monitor, television, or other readout device. Answers from experts 175 may be shown on the display such as a touch display. As illustrated, the screen can have multiple frames such as four frames for the recognized transcript, answers from two experts 175, and an advertisement. Additional frames can be provided so that additional answers from other experts 175 can be presented. For example, one frame can display the text of the user request, transcribed by an automatic speech recognizer or typed by the user. A microphone button can also appear so the user can make a new verbal request or respond to an answer by voice. A keyboard button can allow the user to activate a keyboard to make a text request or respond to an answer by text. In this example, two frames contain answers from two experts 175, respectively. For instance, a first answer from a first expert 175 is in the top answer frame. If the user taps anywhere in the top answer frame, the expert 175 can provide additional information, in this example information about the Berkley Barber Shop. This additional information may occupy the entire screen or may occupy the first expert's frame. In this example, a red “X” button allows the user to delete the first answer, which may remove it from the screen and provide negative feedback to the dialog federator 125. The vendor's name can be optionally displayed or may be maintained as anonymous so that user feedback can be performed without bias. The information shown in the next frame is an “answer,” though it may not actually answer the question. In this example, the expert 175 asks for clarifying information (in the expert's bid). The user can select one of the buttons for more information or to take action. Thumb icons or other graphic indicia can allow the user to express opinions on the quality of one or both answers, such as by voting to like or dislike the respective answer. The bottom frame can be an advertisement, selected to be relevant to information known about the user, the user's history, the user's request, and/or the expert answer(s).

Many other screen divisions and configurations can be utilized by the exemplary embodiments. For instance, one selected answer and a paid advertisement can be presented, such as the advertisement also being an answer from an expert 175. This presentation can be responsive to where no suitable second answer exists. In another embodiment, one answer only can be presented, such as in the event that the advertising space was not sold or to give the answer more space. In another embodiment, two bids and no advertisements can be presented. In another embodiment, a larger screen (such as where the client 110 is resident at a set top box that is presenting content via a television) may have many bids and advertisements. In another embodiment, answers may be text-only or may include graphics, video, audio, games, haptics, and/or other media. In another embodiment, answers may comprise a software application or files that affect how other applications run.

In one or more embodiments, the dialog federator 125 and/or client 110 may provide a series of answers, of which a subset are visible at a given time and where the user may scroll between answers, such as by using buttons, soft buttons, and/or gestures. In addition to or instead of the display, other output technologies may be used to provide answers. Examples of output technologies may include a robot, toy, vehicle, indicator light, home appliance, TV, car, music or video player, and/or other device that performs action (including computation actions, communication actions and/or physical actions) based on the answer. For example, an answer to a request to wash the dishes may include actuating a washing machine appliance to commence washing of the dishes.

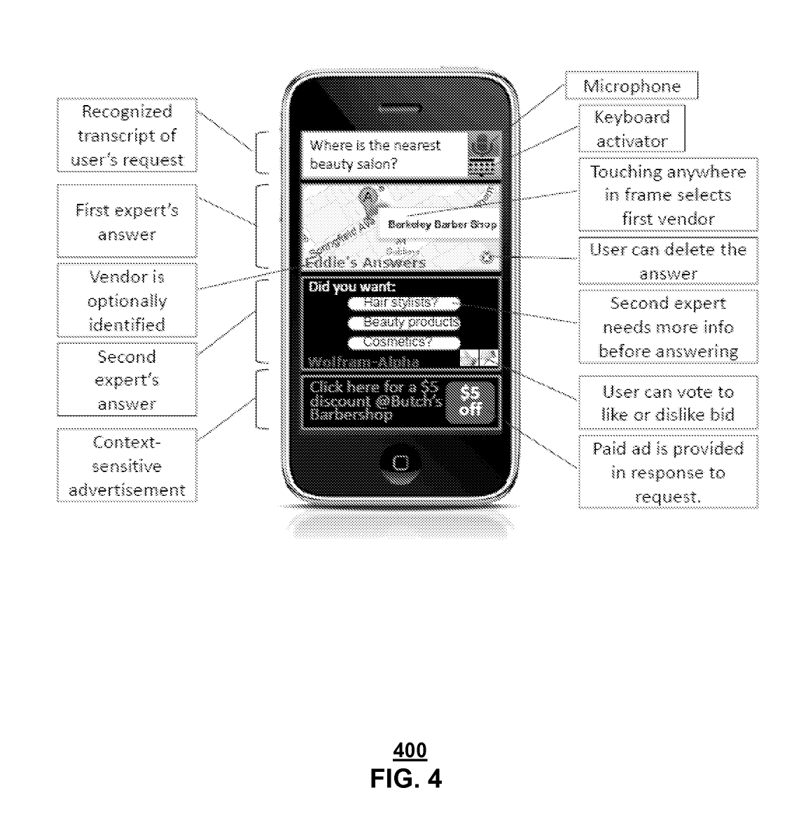

Referring additionally to FIG. 5, the dialog manager 500 of dialog federator 125 is illustrated in more detail. In one exemplary embodiment, the user interface is part of a client 110 and the dialog federator 125, API 150, and experts 175 are in the network, but it should be noted that any of these components may be in the client, in the network, in a combination of both, or elsewhere. A session or conversation between a user and a virtual assistant (e.g., experts 175 via the API 150 and dialog federator 125) may be described as a series of dialog turns. A turn can be defined as a prompt being provided to a user and its associated request received from the user. Prompts and requests may occur in either order. When there is no associated prompt, a request may be considered a turn, and vice versa.

In one or more embodiments, a user interface manager 510 can control the input to and output from the client 110. In one example, the interface manager 510 may execute basic dialogs, though it may leave more complex features to the experts 175 (e.g., providing answers from a local memory based on analysis of terms or phrases understood locally but transmitting requests when the terms or phrases are not understood). The interface manager 510 can receive answers from experts 175 chosen by the bid selector 240 and can forward the answers to a prompt generator 520.

Output from the user interface manager 510 destined for the client 110 can be fed to the prompt generator 520 for formatting and/or conversion as needed. For example, the prompt generator 520 may specify the font size or color for text output, translate a prompt to a different language, and/or assemble recorded prompts from recorded segments. Other format adjustments can be analyzing the answers to detect branding (or a lack of branding) and adding branding (or removing branding) based on the analysis. The prompt generator 520 may also be responsible for natural language generation, display formatting, and/or converting concepts into a human readable form. If text-to-speech (TTS) is used for prompts, the TTS may reside in the prompt generator 520 or client 110 or it may be distributed across both. In one embodiment, if a video or online game is downloaded to the client 110, the prompt generator 520 may be responsible for embedding it into a screen display of an end-user device.

A prompt may be an initial signal from the dialog federator 125 for the user to respond or it may be an answer to one or more previous requests from the user. The terms “prompt” and “answer” may be used herein interchangeably to denote a message provided to the user or other action taken by the virtual assistant client in response to or to elicit a user request. Sometimes, such as in the context of speaker identification, the prompt may be called a challenge. Examples of prompts or responses include spoken output from text-to-speech, recorded voices, beeps, music, or other audio; vibration or other haptic output; text; video or other images on a display; indicator lights; electromechanical movement; and/or other means used to signal the user.

The client 110 can be a device or software that provides an interface to the user. In one embodiment, the client 110 may be a home appliance such as an alarm clock or television, a computer, a digital tablet, a smartphone, a robot, or other electronic or optical device. The client 110 may accept a prompt or an answer from the dialog federator 125, collect a user request and forward it to the dialog federator, and/or solicit and capture feedback from the user. The user's request may be a response to a prompt from the dialog federator 125 or it may be a spontaneous command from the user.

One example of a conversation with a virtual assistant via a client 110 is a question/answer scenario as follows:

User: “What time is it?”
Virtual assistant: “It's 3:30 pm, time for your budget meeting.”

Another example is a prompt/response scenario where the virtual assistant takes the initiative:

Virtual assistant: “What is your password?”
User: “One alpha dynamite five.”

The request that is described in the exemplary embodiments can be input from the user, including the two examples above. A request may be from the user posing a query or asking a question, replying to a question posed by the dialog federator 125, making a comment, and/or stating a command. The request may comprise a text string, touch tone, screen tap or click, clicking or pressing a button, activating a switch or knob, pen input, an utterance such as spoken input, a gesture such as a word or phrase in sign language or mouthed by moving lips, a spoken word or phrase combined with video of the lips to generate a more accurate recognition result, one or more images showing the user's face and used to determine the identity of the user or to steer the pickup beam of a directional microphone, moving or rotating the device in space, and/or performing a gesture captured by a camera or by a touch display.

The request may comprise passive input generated on behalf of the user such as a function of the speed of a vehicle, arrival at a given location, biometric input such as a finger print, heart rate, EKG, or EEG signals, temperature, weather information, data extracted from a database or web page, an event triggered by the value of an account balance reaching a threshold, output of a software application such as a smartphone app, an arrival at a predetermined date or time of day, activation or control of a machine (such as a vehicle), or other action by the user. The client 110 may, for example, comprise a browser, such as an HTML5 browser, running on a device, a software application running on a device, and/or an operating system running one or more software applications.

In one or more embodiments, a client 110 may provide a means for the user to rate the quality of answers or bids from experts 175. Feedback may comprise any action taken by the user. The feedback may take the form of selecting thumbs up or down icons, marking five-star rating scales, freeform text input, verbal feedback, and/or menu selections. Feedback may also be gathered by observation of how the user interacts with or chooses not to interact with the prompt. A delete symbol such as a red “X” button may appear with an answer, so that if the user clicks the symbol, the expert receives negative feedback. Feedback may be collected from a survey taken, for example, after a turn or series of turns or from a follow-up call. User feedback may gleaned by tracking whether a user clicks on a map to magnify, selects an option for further interaction, selects a coupon, answers a question from the expert, clicks a link, dials a phone number provided by the bid, and/or otherwise indicates that the bid was or was not of value. In one or more embodiments, if a user clicks the microphone to issue a new request without interacting with any of the presented answers, this may also count as or be deemed as negative feedback for the presented answers.

In one or more embodiments, a provision may be included to allow users to provide retroactive feedback for answers from the past, such as when an answer later proves to be less useful than originally thought. For example, an application may appear to transfer money, predict the weather, answer a question, book a reservation, and/or take some other action and the user may later discover the information was incorrect or the action not correctly taken. The provision may allow users to look or search through past answers and add or modify feedback or report serious offenses.

In one or more embodiments, different actions may result in varying degrees of positive or negative feedback. For example, ignoring an answer may be counted as a smaller degree of negative feedback than selecting a thumbs-down icon. Ignoring a complete answer, one that provides value without further user interaction, may result in a lesser degree of feedback than ignoring an answer that leads to or requires a multi-turn conversation. In one or more embodiments, the dialog federator 125 may provide to experts 175 some or all of the user feedback, an indication of which experts the screener 235 and bid selector 240 chose, and/or other information on how experts are screened and bids are selected. Experts 175 may use this information to improve their own performance, such as to better decide how and when to bid and how to improve the quality of their answers.

In one or more embodiments, user feedback can be recorded and analyzed by a scorekeeper 530, which compiles feedback records and generates feedback statistics or ratings. For example, the scorekeeper 530 may track the number of times an expert's bid is presented and the number of times the thumbs up or “like” button is pressed, and then calculate overall percentages. These percentages can be examples of a rating that indicates how valuable the users found the expert's bid. The scorekeeper 530 may incorporate a forgetting factor that weights more recent feedback more heavily than old feedback. The scorekeeper 530 can put some or all of the feedback and ratings information into a dialog memory 575 for use by various components of the dialog federator 125.

A number of strategies may be employed to prevent vendors from “stuffing the ballot box” or to prevent hackers from sending malicious or deceptive feedback. One example strategy can include ignoring or discounting ratings above a predetermined number sent from near the vendor. For example, ratings from the same IP address, company, or geographical location as the vendor may be discounted by, say, 90%. Another example strategy can include ignoring or discounting multiple ratings from the same user or group of users. For example, the rating may be weighted by 1/(1+dn), where d is a discounting factor and n is the number of ratings previously provided by the user. If d=1, then the weight will count the ninth rating only one-tenth as heavily as the first rating from that user. Another example strategy can include hiding the vendor identity when ratings are collected. For example, if the thumbs-up icon appears only 1% of the time so that feedback is only solicited on a sampling basis, then the vendor is not identified when the icon appears. Another strategy can include limiting the number of ratings allowed in a predetermined time interval. Another example strategy can include tracking user behavior to determine whether the user is trying to skew results. For example, if a user only rates answers to a specific class of requests and consistently votes for a particular expert, the user may be suspect and his/her feedback may be ignored or discounted. Another strategy can include keeping a new or modified expert's answers from the general population of users until a certain waiting period passes, a certain number of answers have been provided, it is approved by a reviewing body of judges, the expert's answers have been field tested on a select set of users such as beta testers or volunteer judges, or other criteria have been met. This auditioning process may apply to all new experts or to a sample of experts and may include both new and tenured experts. Another example strategy can include tracking whether ratings change if the vendor's name is hidden in the device display.

In one or more embodiments, users can generate ratings. For instance, ratings can be generated by one or more judges who are paid or volunteer to assign ratings or to review and rate experts 175. The role of judge may be, for example, crowd-sourced or offered in return for benefits such as additional exposure for experts made by the judge's company. Judges may be testers affiliated with the sponsor company providing the virtual assistant service. Judges may be users of the virtual assistant services who have volunteered to accept a different or experimental user experience and provide input. Judges may be automated systems, humans, or a combination of both.

In one or more embodiments, judges may play a role in filtering or censoring undesirable answers, such as those that may contain potentially offensive, pornographic, profane, illegal, plagiarized, malicious, deceptive or other undesirable content. A process of reporting, flagging, and confirming undesirable answers may allow both users and judges to help police bids from experts. A judge's ruling may designate an undesirable answer or other offense by an expert 175 as serious, triggering special treatment of the case. A first judge's ruling may generate a report to be reviewed by a second judge before action is taken.

In one or more embodiments, ratings may also be automatically generated. For example, an intelligent expert may recognize phrases such as “what time” or “which NFL team” and give points to experts that answer with times or football teams, respectively. In a second example, the dialog federator 125 may send test requests to the API 150 where the answer is known, and observe which experts 175 provide the correct response. In a third example, the relevance of an expert's answer is tested, such as by comparing word similarity or measuring a statistic such as tf-idf.

In one or more embodiments, ratings may be generated by comparing outputs from multiple experts 175. For example, if three experts 175 provide the same answer, they may receive points based on an assumption that similar answers are more often correct. These points may affect the experts' ratings or may be included in screening and bid selection. Ratings may be adjusted based on mitigating circumstances, such as users who consistently award high or low scores or a low-confidence speech recognition result in transcribing the user request (which could lead to an unsatisfactory answer).

Experts 175 may call or use each other, in a manner similar to how computer software calls a subroutine, which could trigger a rating adjustment for the called or calling expert 175. The rating adjustment in this example can be a reward or punishment for a good or poorly performing expert, respectively. Experts 175 can perform various functions, including buying and selling ratings points; getting points for providing their own source code where other vendors can see and use it; and/or getting points for uploading object code that can't be read by others, but is now in the sponsor's cloud, which can help insure that the expert may continue to be available long-term and may help system reliability, compared to a scenario where the expert runs on a vendor's server.

The sponsor may accept payment or other benefits from expert vendors in return for higher ratings, greater exposure, preferential bid selection, or other considerations. An expert 175 may get points if a user marks that expert as preferred in a user profile. Experts 175 may get points for the number of turns a user takes in a conversation or in seconds of user speech. Experts 175 may get points for completing a transaction. Successful transaction completion may be measured from the number of turns taken, a message from a transaction server indicating success or failure, and/or by a survey, such as by prompting the user to indicate success or failure and collecting a response. Ratings may be collected via a system or device, such as a web page, separate from that used by the application. Experts 175 may rate answers from each other. Ratings from experts may be used by the scorekeeper 530, screener 235, and/or bid selector 240 in evaluating other experts 175.

Rating information can be used to guide expert selection by the screener 235 and the bid selector 240. Ratings provide motivation for vendors to build experts 175 that deliver quality results. By tracking and using ratings, the dialog federator 125 can encourage experts to only respond when they are likely to have a bid the user is likely to accept. An expert 175 may, for example, employ a strategy of focusing on a narrow specialty such as banking or answering questions about baseball scores or managing the user's calendar where the expert has been carefully designed and thoroughly tested. In one or more embodiments, experts 175 may keep their ratings high by only responding when they are confident of their bid or when the request falls within their domain of expertise.

If the number of experts 175 is large or if resources are limited, it may be impractical or expensive for all experts to respond to a request. It may also be unnecessary to invite all experts to respond, such as when the bid selector 240 is able to make a decision without examining the experts' bids, such as when the selection is based on the experts' history or specialty and not on the content of the current bid. In another embodiment, the screener 235 can be utilized to pre-qualify experts 175 based on a prediction of how likely the expert's bid is to be accepted, and invite only likely winners to respond. The screener 235 can use session metadata to select a subset of experts 175 to receive invites. For example, if the request appears to relate to a user's schedule, invites may be sent only to experts 175 that deal with calendars. The screener 235 may only send invites to experts with ratings above a pre-determined threshold. Some or all of the invited experts 175 may respond to the bid selector with a bid. Criteria used in bid selection and in ratings (described elsewhere in this disclosure) may also be used as screening criteria.

In another embodiment, experts 175 can build their own criteria. For example, an expert 175 may provide code, such as in the form of an equation, software script or routine, or an expression, such as a regular expression. For example, an expert 175 may advise the screener 235 that it will only bid on requests of the format “*(give|tell) me weather info*,” where “*” represents any text and “|” represents an “or” function, so that the screener 235 may only invite the expert 175 to bid on requests that match the provided format. The provided code, with a subset of the session metadata as input, may output a value that indicates whether or how likely it is that the expert 175 will provide a high quality answer. The screener 235 may use this value, possibly in combination with other session metadata, to select experts to receive invites.

In another embodiment, a statistical classifier can be trained that uses session metadata as input and selection of experts 175 for invites as output. The classifier can attempt to determine the user's intent. This classifier may be trained to make selections that maximize positive user feedback on a set of training data. The classifier may alternatively be trained based on a set of examples that have been marked by vendors to indicate each vendor's claim as to whether their expert 175 is suited to each training utterance or by judges to indicate whether the expert's answer was correct. The classifier may alternately be trained based on a set of examples where output of the bid selector 240 is used as the target.

Intent determination algorithms such as statistical and rule-based classification algorithms can be utilized with training data, which may be supplied here by, for example, user feedback, vendor claims, or transaction success. A statistical classifier may be trained on a set of training data to select classes that optimally define the set of experts to receive an invite. The bid selector 240 can choose one or more answers from experts 175 to send to the user to be presented as a visual display, speech, or by other means. The bid selector 240 may use ratings as a factor in selecting which bids to present to the client 110. For example, if an expert 175 consistently gets poor ratings or if users rarely choose to interact with the expert's bids, then the expert's answers may be less likely to be selected in the future.

As illustrated in FIG. 5, the bid selector 240 can consider all or part of the available information, or session metadata, to choose one or more bids. Various strategies may be employed in the screening and bid selection processes such as the bid selector may select the responding expert with the highest rating. Another strategy can include bids being selected in proportion to the expert's voting record. For example, if a user “likes” or gives a “thumbs up” to expert-1 10% of the time and expert-2 20% of the time and only the two experts respond, then the bid selector may choose expert-1⅓ of the time and expert-2⅔ of the time, corresponding to the proportion of their relative ratings. The selection may be random or in a deterministic order. Another strategy can include, at regular or random intervals, the bid selector choosing a new, a newly updated, and/or a low-rated expert 175. This strategy gives experts a chance to get started or improve over time. Another strategy can include a user opting to receive bids from experimental or new experts 175, recognizing that the resulting answers may be less refined but more interesting. Another strategy can include, at various times, such as when little data is available or to collect statistical information, the bid selector 240 choosing answers at random. Another strategy can include bids being tailored to the user. For example, if a user gives positive feedback or otherwise interacts with to a given expert, that expert 175 may be favored for that user in future turns. This provides a pleasant user experience by making it easier for a user to get back to an expert that he/she liked before. In another example, a user's historical behavior may indicate a preference for a certain type of answer, so an answer matching this predilection may be more favorably selected.

In one or more embodiments, users may select preferences in a user profile via a user admin page 550 shown in FIG. 5. These preferences may guide bid selection for that user. For example, if a user indicates that he/she has an account with Chase, then Chase's expert may receive preference over experts built by other banks. In one or more embodiments, users may write reviews of the service, answers, or experts that other users may read. Other users may then favor these answers or experts in their profile. In one or more embodiments, the bid selector 240 may employ any of a number of strategies to prevent the same answer from appearing in response to a repeated request. A few examples include: (a) select bids at random from among leading experts, (b) track repeated requests and exclude answers that have recently been used, and/or (c) favor experts that provide answers that have not been given before. In one or more embodiments, a bid may include an offer of a sum to be paid to the sponsor if that bid is selected. Similarly, a vendor may offer the sponsor an incentive, financial or otherwise, in return for bid placement, either to be displayed as one of multiple answers or to be only answer shown. A bid may alternatively appear as a paid advertisement, in which case user interaction or other voting for the advertisement may count as feedback for the expert. In one or more embodiments, the bid selector 240 may employ any of several algorithms for accepting bids that include payment offers. For example, the bid selector 240 may accept the highest bidder, or the expert 175 providing the most attractive payment offer. In another example, the bid selector 240 may use a combination of expert ratings, financial offers from experts, and other factors in selecting the winning bid or bids. Where multiple answers are presented to the user, the bid selector 240 may use one criterion such as expert ratings for one answer to be displayed and a second criterion such as payment offers for a second answer.

In one or more embodiments, the bid selector 240 may employ a criterion that prefers bids that are different from each other. Selecting dissimilar bids may increase the likelihood that the user receives at least one answer relevant to his/her request. Under certain criteria, the bid selector 240 may choose only one bid, as opposed to selecting two or more bids. Choosing only one bid may give the answer more screen space and may be more appealing to the user. Example criteria for giving a bid more screen space may include: (a) if, instead of asking users to choose among multiple answers, users are shown only one answer and invited to rate the answer; (b) if only a subset of turns are sampled for feedback, then the sampled subset may present two or more bids to the user and non-sampled turns may present only the winning bid; and/or (c) if a first bid is substantially better than a second bid, either based on merit or on financial subsidies or other factors, then only one bid may be presented to the user.

Ratings for an expert 175 may be adjusted based on ratings of the expert's developer, the assumption being that if a vendor has built other high-quality experts or has other positive traits, then that vendor's experts are more likely to satisfy users. An expert 175 may self-rate its own bids, such as by providing a confidence score. This self-rating may be used in bid selection and may be adjusted to compensate for expert bias, such as (1) by normalizing the confidence mean and variance or (2) calibrating the expert's confidence scores based on the expert's performance history. The self-rating may also be used to soften consequences of feedback from users when the scorekeeper 530 computes ratings. For example, if an expert 175 bids on a request, citing a relatively low confidence, and the answer receives negative feedback, then the adverse impact on the expert's rating may be reduced. In one or more embodiments, a user may recommend or invite friends to try a given expert 175, which preferences may factor into the bid selection. Invitations to friends may directly affect bid selection or may only influence the decision if the friends accept the invite. A sponsor or vendor may pay or otherwise provide incentives for users to try an expert as a promotion or to gather data. The bid selector 240 may use a statistical classifier, trained in a manner similar to that described above for the screener 235. When a screen displays multiple answers, one answer may be selected using a first strategy such as choosing the highest rated expert 175 and a second answer may be selected using a second strategy such as choosing an expert at random.

In one or more embodiments, a number of algorithms have been or may be developed for searching web pages. One or more of these algorithms may be adapted to the screening and bid selection processes, such as by considering the user request as the search phrase and the expert's answer as a web page. In one embodiment, the bid selector 240 may compare outputs from multiple experts 175 to select a bid. The bid selector 240 may: select experts that give similar answers where agreement across experts may be used to indicate a higher confidence that the answer is correct; select experts that give dissimilar answers to give a greater diversity of answers, such as when multiple answers are presented to the user; and/or combine answers from multiple experts to create a better answer. For example, high-confidence portions of two or more answers may be used to create a single answer.

The bid selector 240, optionally in conjunction with other modules such as the prompt generator, may filter for potentially undesirable answers, such as those that may contain offensive, objectionable, pornographic, profane, illegal, plagiarized, malicious, and/or deceptive content. In one or more embodiments, user preferences such as options selected on the user admin page may guide filtering. External services such as NetSpark.com may be employed as filters. Searches may be routinely performed or performed on a schedule such as random sampling to determine whether answers have been plagiarized, stolen, copied from information provided by the federator, adapted, or otherwise inappropriately obtained from third-party sources. Software, human reviewers, and/or other processes may be employed to detect phishing, spam, server flooding, denial-of-service attacks, or other fraudulent activity. Software or other processes may be employed to detect experts that provide random or useless answers. In one or more embodiments, if the bid selector 240, other modules, search engines, human judges, and/or other entities determine that one or more answers may be in violation of established terms and conditions, nominally stated as part of a process of registering experts 175 to connect to the API 150, the dialog federator 125 may report a violation. The violation may be further reviewed to determine appropriate action. Depending on the offense, an expert or vendor may be barred from participation or subject to other penalties.

In one or more embodiments, the bid selector 240 may take a weighted sum of multiple indicators to determine a discriminator for each bidding expert and may compare the discriminator to a threshold. The expert or experts with the highest value of the discriminator may be selected. Indicators may comprise one or more of: the expert's rating (has a positive weight); a function of whether the vendor is paying the service provider for answer or ad placement (has a positive weight); an automated estimate of the expert's answer's quality, such as whether the answer uses terminology that belong to the same topic or set of terms used in the user's request, such as a metric used in searching web-pages such as tf-idf may be used as an automated estimate (has a positive weight); and a measure of how similar the expert's answer is to answers from other experts (may have positive or negative weight). It will be obvious to one skilled in the art that signs of indicators and the comparison may be reversed. Since ratings, screening, and bid selection can be related, criteria used for ratings can be used for screening or bid selection and vice versa.

In one or more embodiments, for spoken input, the dialog manager 500 can include an automatic speech recognizer 560 that listens to the user's voice and transcribes the utterance into text. This text can be output via dialog memory 575 to other elements in the dialog federator 125 and/or to experts 175. The speech recognizer 560 can use one or more acoustic models and language models which may adapt to the user's speaking patterns to obtain increased accuracy. In addition to text transcriptions, the speech recognizer 560 may output additional information such as a lattice, a word confusion network, an n-best list, JSON objects, XML objects, SISR (Semantic Interpretation for Speech Recognition) tags, EMMA (Extensible MultiModal Annotation language) structures, phrase confidence scores, word confidence scores, named entity tags, pitch tracks, stress markers, language spoken by the user, and/or audio statistics such as the signal-to-noise ratio, estimate of the audio quality, and audio duration. The recognizer 560 may output tags and other information embedded into acoustic and language models such as which section of a language model was used to match the spoken input. Some or all of this output from the recognizer may be provided to experts 175 by the screener 235 via the API 150.

In one or more embodiments, experts 175 may not necessarily need to rely on the speech recognizer 560, but may employ independent speech recognizers in one embodiment where the dialog federator 125 provides audio. In another embodiment, experts 175 may rescore a lattice or word confusion network provided by the speech recognizer 560 in FIG. 5 or may combine their recognized results with the recognizer in FIG. 5. In one scenario, acoustic models and language models such as grammars and hierarchal statistical language models may be part of the speech recognizer shown in FIG. 5. In another embodiment, experts 175 may provide model components such as grammars, pronunciation dictionaries, language models, vocabulary lists, and acoustic models. The speech recognizer 560 of FIG. 5 may then combine components, such as by running grammars from experts in parallel, with each grammar weighted as needed to obtain an optimum result based on accuracy metrics or user feedback. In another embodiment, an expert 175 may rescore the lattice, n-best list, and/or word confusion network output of the speech recognizer 560 according to criteria selected by the vendor or expert 175. In another embodiment, an expert 175 may run its own speech recognizer or provide grammars or language models to the federator's automatic speech recognizer to be run for its own use.

The speech recognizer acoustic and language models may evolve to become more accurate as the service gets started and as user behavior changes over time. In one embodiment, as users use the virtual assistant of method 300, the systems saves data such as transcriptions from the automatic speech recognizer 560, log data, session metadata, information stored in session memory and the registry, and/or audio recordings. Some of the audio recordings may be transcribed by human data entry personnel. Model training software may then use saved data to retrain the speech recognizer 560, such as by building or adapting acoustic, language, classification, and other natural language models. For increased accuracy, the speech recognizer 560 may adapt to the user's voice. One challenge with traditional speaker adaptation is that adaptation may be impaired if adaptation is performed when there are speech recognition errors. In one embodiment, there is only adapting or adapting more fully when the user provides positive feedback or participates in follow-on turns or based on responses from experts such as transaction success.

In one or more embodiments, the dialog federator 125 may aid experts by providing the output of a natural language processor (NLP) 570. This information is provided to experts 175, though experts may also implement their own NLPs. Output from an NLP 570 can help experts 175 formulate a response and decide whether to bid. The NLP 175 may contain multiple language processing modules such as a classifier, a part of speech tagger, chunker, named entity extractor, and/or parser. The classifier of NLP 570 may indicate the intent of the user and attempt to assign the request into one or more of a number of intent classes. The classifier may be the same classifier as that used by the screener and the bid selector, which may themselves be separate or combined. The part of speech (POS) tagger of NLP 570 can mark words or phrases according to their syntactic role (e.g. plural noun, adverb). The chunker of NLP 570 can divide a sentence into segments such as noun phrases and prepositional phrases. The named entity extractor of NLP 570 can mark elements according to categories such as phone number, person, time of day, or location. For example, if the user says, “remind me to take my pills at noon,” the parser may output:

<INTENT> Remind me </INTENT>
to <ACTION> take my pills </ACTION>
at <TIME> noon </TIME>

A parser may perform lexical and syntactic analysis to analyze text and determine its grammatical structure. Other NLP modules (not shown in FIG. 5) such as language translation, sentiment analysis, and/or co-reference resolution, are possible and may be part of the NLP 570. The natural language processor 570 can take input from various elements of the system (e.g., the speech recognizer 560) via the dialog memory 575 and return the result to the dialog memory. By providing natural language information, experts 175 may be better able to decide whether to bid and to respond with the correct action.

A dialog memory 575 serves as a storage location for information used or created by elements of the dialog federator 125. It may contain information for the current session and historical information, such as from previous sessions. Elements of the dialog memory 575 may reside in a single location as illustrated in FIG. 5 or may be distributed across the system. The dialog memory 575 may read or write to a log, for example to save or retrieve historical data. Part of all of the session metadata and information stored in the dialog memory 575 can be saved into a log for future reference and for off-line research and development. Part or all of this log data may be stored in log 585 of FIG. 5. Some of this log data may be made available to vendors for use in developing and improving experts and to experts for providing better answers. How much log data is shared may depend partly on privacy settings specified by the user in his/her user admin page and privacy settings specified by the sponsor and vendors. The dialog federator 125 and/or experts 175 may utilize network storage to store information or share information with each other or with external services. For example, the dialog federator 125 and experts 175 may use, for example, a personal cloud, to save and retrieve personal information such as credit card information, medical records, drivers' licenses and social security numbers, driving records, music preferences, and/or smartphone configuration data. The dialog federator 125 and experts 175 may also use network storage to save or retrieve weather information, stock prices, video, music, audio books, software, entertainment, and/or other content.

In one or more embodiments, certain transactions may require payment from one entity to another. Example transactions can include vendors paying the sponsor for preferential selection in screening and bidding. As another example, the sponsor may pay vendors for bids, winning bids, or for positive user feedback. As another example, experts may pay or charge users for products or services. As another example, experts and the sponsor may pay or charge each other. For instance, the sponsor may pay vendors or provide other benefits in return for the vendors transcribing audio into text and classifying utterances. Vendors may also volunteer to transcribe and classify user input in return for exclusivity or other benefits or to get advance copies of the transcribed data. As another example, users may charge each other for goods and services. As another example, advertisers may pay the sponsor or experts in exchange for promoting goods and services to users. They may pay, for example, per impression, per click, or per purchase. As another example, users may put money into an account, held by the sponsor or by an expert, to be used against purchase of future goods and services. As another example, the user may provide a bank card number to be kept on file, then charged when an item or service is purchased. As another example, experts may lend users money.

In one or more embodiments, a user may buy an entertainment subscription from the sponsor. The sponsor may pay a first expert a monthly fee for video services. When the user watches a number of movies, the first expert may pay a second expert a per-movie fee for movies watched. For financial transaction scenarios such as these, till 595 in FIG. 5 may be used to keep a ledger of money on the accounts of users, experts, vendors, advertisers, and the sponsor. Money may be in the form of dollars or other real currency, credit that may be used for purposes such as advertising or ad placement, or points that may be used for preferential treatment in bid selection. The till 595 may connect to an internal exchange or external agency, such as PayPal or a bank, for converting internal money into cash.

In one or more embodiments, part or all of the session metadata and information stored in the dialog memory 575, log 585, till 595, and information from the user administration page 550 can be saved in the registry 245 for access by experts 175 and the dialog federator 125. Experts 175 may also publish information to the registry 245. The entity that provides or controls the information may also designate privacy settings for that information. Privacy options may include public (available to all experts), private (available only to designated experts such as experts interacting with a given user), or exclusive (available only to the entity writing the information). Registry data may be encrypted for additional security. Session metadata may be provided to experts 175 either via the screener as part of the invite or via dialog memory 575 by way of the registry. In one embodiment, experts 175 providing information may get paid by other experts or by the sponsor or receive other benefits such as preferential bid selection for this information. Examples of registry information may include: 1) user's name, phone number, location, destination, velocity, credit history, credit scores, and other personal information; 2) whether the user has yet passed a speaker verification challenge—if yes, the user may have access to more services than an unconfirmed user; 3) output of the speech recognizer 560, NLP 570, and ratings of experts 175; text and audio of a user's request; record of the previous and past sessions and turns for the current user; the dialog state; the user's profile information, contact list, and calendar; user's credit card or other account numbers, user IDs, and passwords; dialed phone number, email address, Skype handle, or other destination identifier; a user's social networking login or account name; the result of a speaker identification or verification challenge—if the user's voice sample matches or fails to match a voiceprint on file, then attempt results may be saved in the registry so that other experts know to what degree the user's claimed identity can be trusted; and/or a user's device identifier such as a phone number or UDID.

In one or more embodiments, users can log into a profile and preferences administration page, such as a website being hosted by the sponsor or a vendor. Users may provide information such as name, contact names, social media account names and passwords, financial account information such as credit card numbers and bank account numbers, and frequent customer numbers such as airline or hotel memberships. User may train biometrics such as voiceprints and register passwords. Users may authorize the sponsor to access services such as club memberships, accounts, calendars, and contact lists. Users may also indicate preferences that may tailor their experience with the dialog federator 125. Users may provide preference and personal information that raises or lowers the likelihood that a given expert 175 will be selected to respond to a request from that user. For example, a user may select a category or list of experts 175 that are allowed to respond or a list of blocked experts. A user may select a category or list of experts 175 to be given bidding priority. A user may select key words or phrases used in interacting with experts 175 or with the dialog federator 125. A user may select virtual assistant options such as how many answers from different experts to show in the display and whether to receive a free service with more advertisements or a paid service with fewer advertisements. Vendors may also host admin pages as companions to experts. For example, a bank may use a web site to let users authorize an expert to access bank accounts.

In one or more embodiments, a dashboard 580 can give a current and statistical readout of overall system performance. The dashboard 580 may show, in text or graphically, facts such as traffic volumes, ratings and performance of individual experts 175, and user behavior and demographics. This information may be useful for, for example, demonstrations, publicity, expert tuning, and/or system monitoring. Part of the dashboard 580 may be a leaderboard. Publicity may be used to motivate vendors to deploy experts 175 and to make them work well. Ratings may be published on a public leaderboard, showing, say, the top ten experts, in predetermined categories or among all experts, for the day, week, or for all time. The leaderboard may also list the top visible (e.g., others may read the source code) and/or open source experts. Vendor profiles may list the vendor's skills, expert ratings, resume, or ads for the vendor's products or services.

In one or more embodiments, the API 150 can be a control & communications channel for the dialog federator 125 to communicate with experts 175. The sponsor can publish an API specification and can manage an account subscription process to give vendors access to the interface. The API 150 may be the same for all experts 175 or there may be multiple API contexts that each cover a class of experts. The API 150 may use a REST interface or other means for allowing experts 175 to register with the dialog federator 125 and make themselves available to receive requests, respond with bids, and/or share information. The API 150 may also enforce a desired degree of format uniformity in bids. Uniformity may aid in presenting a consistent look and feel to the user. An example of an answer format may be a template with fields such as text fields, a fixed or variable number, size, and color of displayed buttons, and/or an image of a predetermined size. Another example may be an assortment of templates, where the expert 175 selects a template and populates fields in the selected template. Another example may utilize a markup language such as HTML5 where the expert 175 is allocated a screen space of a predetermined size and may bid with a structure that fits in that space. The dialog federator 125 may grant a wider range or more flexible set of API options to vendors or experts who have earned or purchased a greater degree of trust.

Although the dialog federator 125 may handle certain tasks for the user, a community or marketplace of experts 175 can provide a broad range of features without requiring custom integration or complex business relationships between companies. Experts 175 may be expressed in software such as JavaScript, Python, C/C++, Java, VoiceXML, HTML, or tables such as .csv files that contain question-answer pairs. Experts 175 may run on the sponsor's or vendor's servers and may be proprietary or open source. Experts 175 may be given a time limit to respond. Alternatively or in combination with a time limit, the bid selector 240 can entertain bids until a predetermined criterion has been met, such as receiving a predetermined number of bids or estimating that it is likely that a quality bid has been received. In one or more embodiments, experts 175 can receive, nominally together with an invite, information such as a recognized text string from the user. Experts 175 may also receive input from other sources inside or outside the dialog federator 125.

Table 1 gives examples of experts, companies or vendors who might use or provide the service, and sample voice commands relevant to each expert:

| Expert topics | Sample vendors/customers | Example requests |
|---|---|---|
| Weather | Weathernowin IL.com | What's the forecast for Chicago, IL? |
| Navigation | NAVCO | Directions to 3009 Waverlylawn Street. |
| Points of | | Discount parking. Nearest gas station to this |
| Interest | | highway. Gas on the way to my destination. |
| Business search | Directory Pages | Where can I buy toys? Where is the nearest |
| | | Burger Village Restaurant? What day camps |
| | | in the area. |
| Services | Services directory | Find me an attorney. Catering for 50. I just |
| | | had an accident. |
| Business | | What time does Toys Inc. close? What's on |
| information | | sale at Wholesalers Inc.? When is garbage |
| | | pickup? |
| Banking | Bank of the World | What's my checking balance? |
| Trading | Traders Services | What is XXX trading at? Sell 1000 shares of |
| | | YYY. |
| Other financial | IRS, Stock Brokers | Receive child support information. Check |
| | Inc. | tax refund. Activate online service account. |
| | | Update account information. |
| Mortgages | Mortgages Corp. | Make my next mortgage payment. I need to |
| | | refinance my house. |
| Investments | Investors Corp. | Treasury yields. Sell my Aero-industrial Inc. |
| | | shares. |
| Q&A | Wolfram-Alpha, | How many furlongs in a mile? What time is |
| | Chacha, Yelp | it? |
| Wikipedia | Wikipedia | Look up saber toothed tiger |
| search | | |
| Web search | Bing | Search for jokes regarding lawyers. Song |
| | | lyrics for “Carry me forward.” |
| Web surfing | | Open www.finderpages.com |
| Shopping | ebay, Amazon | Shop for shoes |
| Payments | Chase, local utilities, | Pay for this item from my Bank of World |
| | VISA | savings account |
| Social media | Twitter, Yahoo | Post to SocialNetwork.com. Send a tweet - |
| | | Order the pizza, I'm almost home. What |
| | | topics are trending today? Recent tweets |
| | | about Robert Downey Jr. |
| Music | iTunes, MPA, | Play ‘Yellow’ by Coldplay. Classic Rock. |
| | Paramount | |
| Video | Warner Brothers, | Watch the latest Big Bang Theory. Pirates. |
| | Hulu.com | Sports on YouTube. |
| Dictation | | Note to self, pick up eggs and milk |
| SMS | | Message Rick White Meet me at 5:00 |
| Read email | | Read my email |
| with TTS | | |
| Send email | Yahoo | Email to mom Did the package arrive yet? |
| Phone dial - | Tel. Phone Co. | Call Jack Relish. Dial 606-521-1392 |
| voice or video | | |
| Communication | Skype | Skype mom. Call Larry Davorski on |
| | | FaceTime. |
| Control or | QNX, Panasonic | Tune radio to 107.9. Temperature 74 |
| monitor vehicle | | degrees. Lock doors. Activate wipers. |
| functions such | | |
| as temperature | | |
| and radio | | |
| Connected | ADT | Close garage door. Who is home right now? |
| home | | |
| Games | EA Sports | Play World of Warcraft. Download chess. |
| Software | Apple App Store | Find an app that balances my checkbook. |
| News | abcnews.com | Today's headlines. News about the Shell |
| | | Exxon merger. |
| Sports | | USU schedule for the year |
| Gambling | | What's the spread on the Cowboys game? |
| Horoscope | | Will I have a car wreck today? |
| Launch apps | App developers | Activate camera |
| Control apps | Apps built into | Display photos |
| | smartphone | |
| Events | Chamber of commerce | Does Madison have a farmers market? What |
| | | childrens' activities are happening Saturday? |
| Reservations & | OpenTable, Olive | Dinner for two at Lowry's. Call a cab. |
| ticketing | Garden | |
| Ticketing | Ticketron | How much are tickets to Sheryl Crow? |
| Movies | moviefone.com, AMC | What movies are showing at the Ogden 6? |
| | | Buy two tickets to Scream 9. Science fiction |
| | | movies this Friday. |
| Entertainment | | Where are cheap places to go on a date? |
| Clubs | AutoClub, Retirement | Chess clubs. Is there a mom's walking group |
| | Club | nearby? What time do I look for the meteor |
| | | shower? |
| Travel | Airline Inc., | Rent a car for my New York trip |
| | hotwire.com | |
| Schedules | Train Inc. | When is the next train to Buffalo? |
| Reviews - | Sergio's | What is the highest rated digital camera? |
| restaurants, | | Where is a good restaurant? How do you |
| products, etc. | | like the Pasta Garden? |
| Calendar | Doctor's offices | When is my next appointment? Set up a |
| | | meeting with Bruce Monday. Remind me to |
| | | take out the trash Monday at 6pm. |
| Manage contact | | Add a new contact |
| list | | |
| Reminder | | Remind me to empty trash when I get home. |
| | | Wake me at 6:00am. |
| Digital | | I don't like the new CBS anchor - what do |
| companion | | you think? |
| Sales tracking, | Salesforce.com | Who do I need to call today? Show sales |
| leads, and | | against forecasts. Notes from the Dell |
| appointments | | meeting - they liked our proposal . . . |
| Jokes | | Will you go out with me? Tell me a joke. |
| Advertiser | DoubleClick | Problems with my digital camera |
| Smartphone | | Turn off Wi-Fi |
| control | | |
| Directory | anywho.com | What is the email address for Bob Anders in |
| service | | Toronto? |
| Confirm | | My voice is my password. |
| voiceprint | | |
| Reset password | | I forgot my password, my name is David |
| | | McElroy and my social is 522-11-1400. |
| Language | | Translate to French, where is the nearest bus |
| translation | | station? |
| Ontologies and | | (Used by other experts) |
| databases | | |
| Help | | What can you do? |
| Casual convers, | | I'm feeling sad today. Should I wear my red |
| (e.g., chatbot) | | or blue sweater? |
| Pay for items at | Walmart, McDonalds, | Pay for these items from my savings account. |
| a retail store | Amazon | Order four tires for my 2008 Acura. |
| Troubleshoot | Comcast | My cable TV isn't working. What does code |
| products or | | 37A on smoke detector mean? How do I |
| services | | silence my ringer? |
| Research | Students, universities | Find Supreme Cases on unlawful search. |
| Emergency | State & local | Is highway 34 open? Where can I get water? |
| information | governments. | Nearest open shelter. |
| Volunteer | | Where can donate blood? Local non-profit |
| opportunities | | organizations. |
| Job search | Gov. Emp. office | Local jobs. Openings for electricians. |
| Education, | Harvard, fitness | Zumba class. Resume algebra lecture. Find |
| classes | centers, libraries | a class on economics. |
| Transportation | City Transport | Train schedules. What bus can I take to the |
| | Authority | Stratford Mall? |
| Services | Boingo | Where is the nearest WiFi hotspot? |
| Prompts | | (An announcement server plays or provides |
| | | recorded or TTS prompts.) |
| Natural | | (An expert serves as an engine for |
| Language | | classification, named entity tagging, or other |
| Processing | | natural language processing.) |
| Auctions | ebay, epier, | Find a used digital camera for sale. Bid on |
| | Priceline.com | the item on my wish list. Offer $50 per night |
| | | for a hotel in downtown Toledo. |

Although the API 150 can be designed to support a broad range of experts, special experts may also be utilized. Special experts can include human agents who read the transcribed text or listen to the user input, then respond, such as by typing a text response or selecting one or more of a set of answers from a list or menu. The decision to send a session to a human agent instead of a software expert may be made, for example, when (1) a classifier, possibly in combination with user input, determines that human attention is warranted, (2) the screener 235 determines that there are no suitable experts for a given query, (3) no automated experts respond or all bids are rejected, (4) an expert that wins a bid invokes a service for follow-on turns that uses human agents, and/or (5) the user subscribes to or the vendor or sponsor offers a premium service handled by human agents.

In one or more embodiments, steps may be employed to deal with the possibility that some experts 175, including human agents, may be slower than other experts. For example, while waiting for the slower expert's answer, the client 110 may show other content such as advertisements, video clips, cartoons, jokes, news, weather, user-selected content, and a message that the answer is on its way or may engage the user in a separate dialog. The dialog federator 125 may display answers at different times, for example, showing an automated expert's answer quickly and then a human's answer when it arrives.

Special experts can be deployed that use a list of canned requests, each paired with a canned answer. Answers typed or otherwise provided by volunteers, paid writers, crowdsourcing workers such as Amazon mechanical Turks, and/or other vendors can be made available, such as provisioning of the client 110 and/or the dialog federator 125. A canned request may be one or more text strings or expressions such as regular expressions that are tested to match user requests. If there is a match, then the canned answer associated with the canned request is provided. Example canned request/answer pairs may be:

Pair 1:

Q: Why is there air?
A: Because 6 billion people are exhaling.

### Pair 2:

Q: What can I buy for [1-5] dollars?
A: You can buy a hamburger. In one or more embodiments, the bid selector 235 may choose one of these canned answers based on an exact match, approximate match, and/or semantic match between the user request and one of the canned questions. There may be more than one valid answer to each question, in which case the expert may, for example, return an answer at random or in sequence from the list of valid answers. Canned answers may include expressions that match a wide range of input. Canned answers may include variables, shown below as words starting with “_” and in all caps, which are recognized in the request and copied to the answer. For example:
Q: [Greeting] My name is _NAME_.
A: Hello, _NAME_. Nice to meet you.

In this example, “[Greeting]” matches “Hello” or “Hi” and “_NAME_” is a person's name, so that, for example, if the user says, “Hi, my name is David,” the expert may respond, “Hello David. Nice to meet you.”

In one or more embodiments, a VoiceXML interpreter that points to one or more VoiceXML pages can be utilized, each of which may alternatively be treated as a separate expert. In one or more embodiments, a “house” expert can be built or otherwise published by the sponsor. The house expert may accept all answers for which there is no other bid, may be used when the virtual assistant service is initially rolled out and few external experts are available, may be used as a benchmark for other experts, or may be a preferred expert.

In one or more embodiments, screen scrapers, or experts that pull info from the web and compile or format it to generate answers to user queries can be utilized. Screen scrapers, which may be experts or may run outside of the federator, may also populate knowledge bases used by experts in providing answers. In one or more embodiments, experts may access content and applications that play on, stream to, download onto, or are stored on the client. Examples include software applications, movies, music, games, social media applications, and databases.

In one or more embodiments, a special expert or class of experts may have the ability to run (e.g., launch) software on the client 110. Alternatively, the expert may provide input to or control a software app that is already running on client 110. The app may run in a frame owned by the client so that the client retains control. The display of the lunched application may include a microphone icon so that additional requests may be made to the dialog federator 125 and that the federator's speech recognizer 560 may be used as a voice interface to the application. This may be useful for experts 175 that deliver content such as media or software that utilizes applications such as media players running on the client.

In one or more embodiments, an answer from an expert 175 may be an advertisement. The virtual assistant of method 300 may also provide screen space allocated for advertisements. Advertisers may be given session metadata to help them place ads that are relevant to the request or user history. Alternatively, the sponsor may use the classifier, screener, and bid selector or similar systems to help select relevant ads. Advertisers may pay, for example, per impression, per click, or per purchase.

In one or more embodiments, speaker verification or identification can be performed by one or more experts. These experts can present a challenge to a user and can attempt to identify or confirm the identity of the user by the user's voice. The outcome of the challenge may be saved in the registry 245 for use by the dialog federator 125 and other experts 175.

In one or more embodiments, experts 175 may provide services to other experts, for example as paid services or to earn ratings points with the dialog federator 125. Examples of such services include speech recognition, natural language parsing, ontologies, text-to-speech synthesis, advertising, user information, providing content, billing services, and/or financial transactions. In one or more embodiments, experts 175 may further subdivide their task to other experts, show as sub-experts 176 in FIG. 5. An expert 175 may form a relationship with sub-experts 176 similar to the relationship the dialog federator 125 has with experts. For example, an expert 175 may delegate tasks to sub-experts 176, in a manner similar to the way a software program calls subroutines. In another example, an expert 175 may send invites to other experts and receive bids, similar to the way the dialog federator 125 sends invites and receives bids.

In one or more embodiments, an expert 175 may specialize in a single topic, meaning that it only bids on questions in that field, or it may specialize in only part of a topic or in a group of topics. There can be a number of factors that may motivate vendors to write and maintain experts, including: the service provider or other entities compensating vendors—compensation may be tied to participation or how many bids are won; performance, such as from the bid selector, may be posted on an electronic bulletin board; and an expert's answer may be an implicit advertisement, such as a service that sells tickets. Winning bids may also be rewarded with advertising credit.

In one or more embodiments, for actions such as reservations, purchases, fulfillment, web search, and/or social media that require access to external processing systems, experts 175 and/or the dialog federator 125 can include or interface to transaction servers 590. Transaction servers 590 may be computer systems at entities such as banks, telephone networks, travel agencies, software stores, information services, directory listing services, data centers, online gaming providers, content distributors such as video servers, review and referral services, websites, and navigation services. The dialog federator 125 and experts 175 may utilize external systems to perform actions such as process payments, make reservations, download content, or access security systems.

In one or more embodiments, a technical interface can be created to the entities and a business relationship can be forged with these entities. In one embodiment, vendors may form the necessary business arrangements with external entities, thus removing this burden from the sponsor. Alternatively, entities providing the transaction servers may create their own experts and offer services directly.

Connections between the dialog federator 125 and transactions servers 590 or between experts 175 and transaction servers may be via APIs such as web APIs designed for web mashups. Transaction servers 590 may be linked to account administration sites available to users. Some experts 175 may not need a transaction server 590 and some experts may need several transactions servers. Multiple transactions servers 590 may share an expert 175 and multiple experts may share a transaction server.

Some transactions may include multiple turns. For example, a balance transfer may require a login step, specification of the dollar amount, and a confirmation step. Confirmation prompts or answers that include follow-up or clarifying questions such as “Do you want to edit message or send message?” are additional examples. These and other dialogs may be more efficient if the same expert or affiliated set of experts handle a series of turns for a given session with the user. Some of the examples presented here are described for a single expert, but it is to be understood that an affiliated group of experts may similarly guide a conversation, cooperatively passing control and the right to be favored in bid selection, within the group. This process of passing control may comprise a first expert nominating a second expert or experts in an affiliated group for a follow-on turn, which nomination is considered as a factor in screening and bid selection. The first expert may also make its registry data available to the second or affiliated expert.

In one or more embodiments, a conversation can be locked or subsequent bids can be locked in, meaning that, once criteria are met, such as that an expert 175 wins a right to provide the bid or receives positive user feedback, that expert can then be favored or “locked” in subsequent bids. The expert 175 can therefore be guaranteed to be selected or given an advantage in screening and bid selection so that the conversation may be controlled by a single expert (or, as explained above, a group of affiliated experts). In a locked conversation where there is no guarantee, but where a given expert 175 is given an advantage, it may be possible for a second unaffiliated expert to win a bid, for example if the first winning expert fails to provide a satisfactory bid or the second expert has a high enough rating to overcome the advantage.

Any of several techniques may be employed to decide when to lock and when to unlock a conversation. The decision may use one or more of the following rules: experts may be classified according to whether user action will lock in subsequent bids—for example, an expert that answers questions may not lock in follow-on bids whereas an airline reservation expert may lock in follow-on bids; clarifying questions and confirmation prompts may invoke temporary locks that are removed at the next turn; and/or if a first expert wins a bid and receives positive user feedback, the expert may lock in subsequent bids. Other techniques can include: (1) an expert that is locked for follow-on bids may decline to bid or may bid with low confidence, allowing the conversation to be released to another expert—there is motivation for experts to volunteer in such manner to yield the lock if they are unable or unlikely to provide a satisfactory answer in a follow-on turn, since otherwise they may risk negative feedback in subsequent turns; (2) user feedback can help discourage experts from holding a lock to the detriment of the user experience, so the process is self-policing—the weight of negative feedback may change in subsequent turns to appropriately discourage locking unhappy users to a poor quality expert; and/or (3) if a user gives an expert's answer negative feedback during follow-on turns, the expert may lose its lock.

In one embodiment, a user can interact with a first expert 175, setting the lock. In subsequent turns, that first expert 175 can receive the screen real estate previously used by other experts, so that the conversation with the user can be more efficient. In another embodiment, one or more competing experts 175, such as unaffiliated experts, can receive a portion of the screen to display their own bids. In this example, if a user interacts with or provides positive feedback for one of the competing experts 175 or if the user provides negative feedback for the first expert, the first expert can lose its lock.

In one or more embodiments, information such as the dialog and other session information from prior turns during a locked conversation may be available to other experts 175 so that the other experts are able to use session information collected so far in constructing their bids. If one of the other experts 175 wins a bid, it may use the prior session information to construct high quality follow-on answers. When a conversation is locked, the winning expert 175 may provide a grammar, language model, and other information to the speech recognizer 560 for use in better recognizing user requests for follow-on turns.

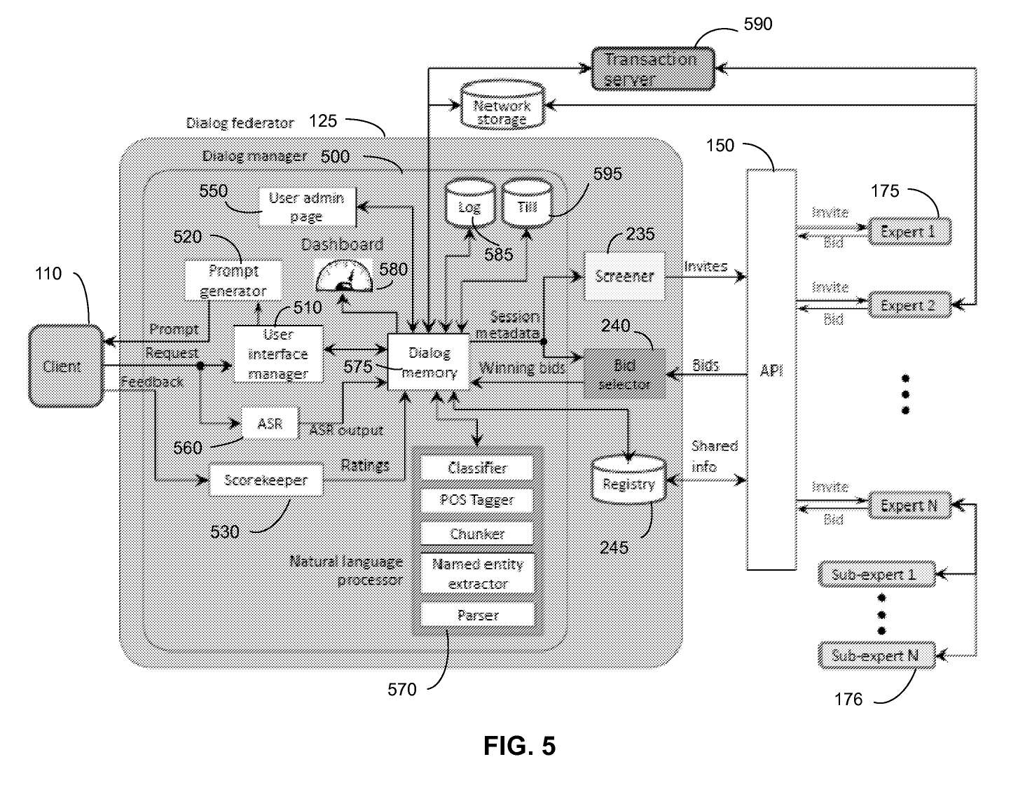

Referring to FIG. 6, another embodiment of a system 600 is illustrated in which experts 175 reside fully or partly on the client 110. The above-described examples included experts 175 that were residing in servers or devices in the network, but the one or more experts can also reside on the client 110 or be distributed between the client and the network. In one embodiment, the task of the expert 175 can run as or is part of an application embedded in the client 110 and can communicate with the dialog federator 125 either via the API 150 or via the user interface manager. One example of this arrangement may be a software application that runs on the client 110 and interacts with a user, such as a smartphone application might, and also communicates with the dialog federator 125. Another example may be where part of the virtual assistant runs in the network and part on the client 110, where, for example, client software runs software downloaded from the network in a client-side asynchronous web application such as an AJAX configuration. In an alternative arrangement, the task of the expert 175 can be shared between an expert and a co-expert, which cooperate to perform the function of an expert and may share information between each other. As illustrated, FIG. 6 shows a first expert, Expert 1, and its companion, Co-expert 1. Either or both experts may communicate with one or more transaction servers 590.

One or more of the exemplary embodiments can utilize multiple expert devices that selectively participate in a virtual assistant conversation without the need for separate expert companies to build a full-featured virtual assistant that would require synchronizing schedules, financing, product planning, revenue sharing, phased development, and other daunting logistics. One or more of the exemplary embodiments can provide a distributed development process for the virtual assistant where, once created, the most accurate answer(s) can be selected among multiple answer candidates.

In one or more embodiments, a method is provided for efficiently coordinating the resources of multiple development teams in building a virtual assistant. This method provides a structure that provides means and motivation for the teams to work independently in the areas they know best, to combine results into one product or service, and to select the best solutions. To minimize cost and time to market, the system can perform the coordination automatically, with minimum human intervention. The exemplary embodiments can enable a set of experts (implemented by expert servers) which are built independently to work together in a coherent service. The system can provide input to and using output from multiple experts that are built to independently designed specifications and/or built at different times.

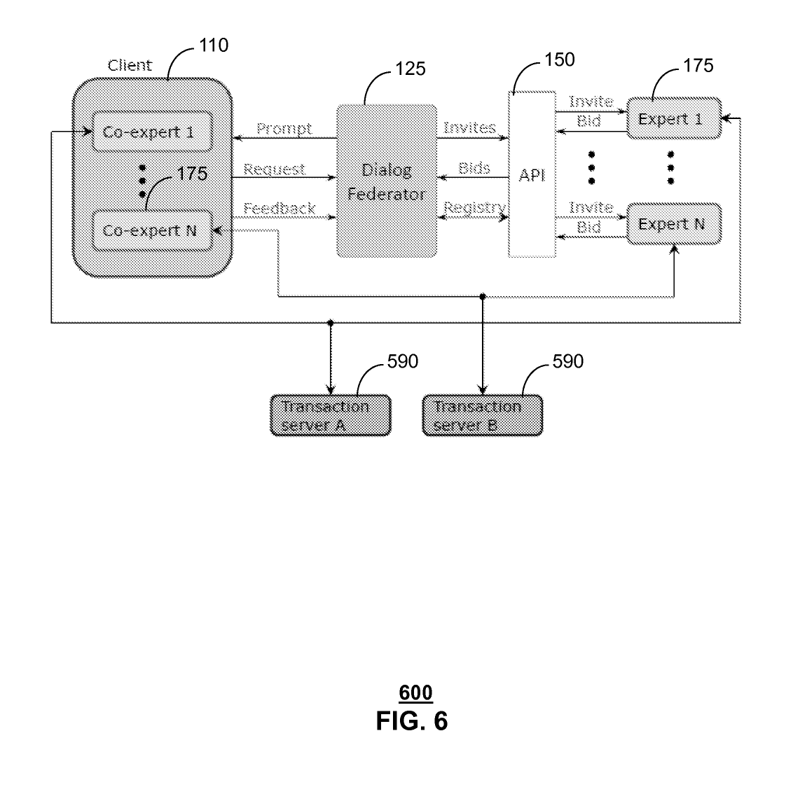

FIG. 7 depicts an illustrative embodiment of a communication system 700 for delivering media services, including providing a virtual assistant at an end user device, where the virtual assistant utilizes multiple expert devices to obtain answers. Communication system 700 can be overlaid or operably coupled with the devices and/or systems of FIGS. 1-2 and 4-6 as another representative embodiment of communication system 700.

In one or more embodiments, communication system 700 can implement a federator function that receives answers from multiple expert devices and selects a subset of the answers to present to an end user device. In one embodiment, the selection of an expert device can depend on user feedback from previous turns, including feedback from previous sessions and other user devices. In another embodiment, multiple expert devices may respond to a federator request, but only a subset are selected. In another embodiment, a rating system, based on user feedback, can assist in selection of the subset. In another embodiment, a dialog federator device and expert devices can share registry data. In another embodiment, the system can receive voice commands and requests.

In one embodiment, communication system 700 enables utilization of multiple classes of experts, where each class has access to a subset of the registry data. In another embodiment, an API can enforce uniformity of answers from the experts. In another embodiment, an expert device may establish and keep a lock on a conversation which gives the expert device preferential bid selection, after the first turn, based on factors such as user ratings for previous turns, user feedback on a given turn, type of user request, and/or continued bidding by the expert. In one embodiment, expert devices can be built by non-coordinated teams. For example, technical connection can be via a uniform API specification. Expert devices can sign up automatically and need no further permission to respond. Cooperation can require no business deal or custom contract other than a uniform vendor agreement. Adding new expert devices may not require changing existing federator code.

Communication system 700 can enable a sponsor to set up a federator and an API. The federator can communicate with a client and the API can connect to expert devices. The API specification can be the same for all expert devices or for each of several classes of expert devices. The business relationship can be the same for all vendors. Vendors can program expert devices independently of the sponsor and of each other. A payment system can optionally reward participants according to user feedback and other factors. An intent classifier can invite a subset of experts to respond. User feedback can guide the selection process. A speaker adaptation module can be guided by user feedback. A business relationship can be established where one company is the sponsor and other unaffiliated companies are the vendors. Expert devices can make payment offers for screen space. Advertisers can bid on ad space.

The communication system 700 can represent an Internet Protocol Television (IPTV) media system. The IPTV media system can include a super head-end office (SHO) 710 with at least one super headend office server (SHS) 711 which receives media content from satellite and/or terrestrial communication systems. In the present context, media content can represent, for example, audio content, moving image content such as 2D or 3D videos, video games, virtual reality content, still image content, and combinations thereof. The SHS server 711 can forward packets associated with the media content to one or more video head-end servers (VHS) 714 via a network of video head-end offices (VHO) 712 according to a multicast communication protocol.

The VHS 714 can distribute multimedia broadcast content via an access network 718 to commercial and/or residential buildings 702 housing a gateway 704 (such as a residential or commercial gateway). The access network 718 can represent a group of digital subscriber line access multiplexers (DSLAMs) located in a central office or a service area interface that provide broadband services over fiber optical links or copper twisted pairs 719 to buildings 702. The gateway 704 can use communication technology to distribute broadcast signals to media processors 706 such as Set-Top Boxes (STBs) which in turn present broadcast channels to media devices 708 such as computers or television sets managed in some instances by a media controller 707 (such as an infrared or RF remote controller).

The gateway 704, the media processors 706, and media devices 708 can utilize tethered communication technologies (such as coaxial, powerline or phone line wiring) or can operate over a wireless access protocol such as Wireless Fidelity (WiFi), Bluetooth, Zigbee, or other present or next generation local or personal area wireless network technologies. By way of these interfaces, unicast communications can also be invoked between the media processors 706 and subsystems of the IPTV media system for services such as video-on-demand (VoD), browsing an electronic programming guide (EPG), or other infrastructure services.

A satellite broadcast television system 729 can be used in the media system of FIG. 7. The satellite broadcast television system can be overlaid, operably coupled with, or replace the IPTV system as another representative embodiment of communication system 700. In this embodiment, signals transmitted by a satellite 715 that include media content can be received by a satellite dish receiver 731 coupled to the building 702. Modulated signals received by the satellite dish receiver 731 can be transferred to the media processors 706 for demodulating, decoding, encoding, and/or distributing broadcast channels to the media devices 708. The media processors 706 can be equipped with a broadband port to an Internet Service Provider (ISP) network 732 to enable interactive services such as VoD and EPG as described above.

In yet another embodiment, an analog or digital cable broadcast distribution system such as cable TV system 733 can be overlaid, operably coupled with, or replace the IPTV system and/or the satellite TV system as another representative embodiment of communication system 700. In this embodiment, the cable TV system 733 can also provide Internet, telephony, and interactive media services.

The subject disclosure can apply to other present or next generation over-the-air and/or landline media content services system.

Some of the network elements of the IPTV media system can be coupled to one or more computing devices 730, a portion of which can operate as a web server for providing web portal services over the ISP network 732 to wireline media devices 708 or wireless communication devices 716.

Communication system 700 can also provide for all or a portion of the computing devices 730 to function as the dialog federator and/or the API. The server 730 can use computing and communication technology to perform function 761, which can include among other things, processing requests received from an end user device (e.g., mobile device 716, media processor 706 and/or media device 708), selecting a subset of expert devices 795 for potential participation in the virtual assistant conversation, providing invites for bids (e.g., answers or other information related to the requests) to the subset of expert devices 795, receiving a group of bids from the subset of expert devices, selecting a subset of bids from the received group of bids and providing the subset of group of bids to the end user device for presentation. The server 730 can also provide for feedback to be compiled and utilized as part of the selection process of the expert devices and/or the selection process of the received bids. The expert devices 795 can include software functions 763 that enable generating answers or bids in response to invites received from the server 730. The expert devices 795 can also generate the bids based on rules, criteria or formats as established by the server 730 (and/or the end-user devices). The media processors 706, the media devices and the wireless communication devices 716 can be provisioned with software functions 762 to utilize the services of server 730 in generating the request for the virtual assistant and presenting one or more of the subsets of the received bids. In one embodiment, software function 762 can include all or portions of software function 761 and/or 763 such that the end user devices can perform one or more of those functions, such as generating responses without providing requests to the server 730.

In one or more embodiments, an API 775 can be utilized to facilitate communications between the expert devices 795 and the server 130. In this embodiment, the expert devices and the server 130 are illustrated as separate device, but the exemplary embodiments can include one or more of the expert devices and one or more of the servers 130 being integrated on a single device.

Multiple forms of media services can be offered to media devices over landline technologies such as those described above. Additionally, media services can be offered to media devices by way of a wireless access base station 717 operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LTE, and so on. Other present and next generation wide area wireless access network technologies can be used in one or more embodiments of the subject disclosure.

In one or more embodiments, system 500 can employ an IP Multimedia Subsystem (IMS) network architecture to facilitate the combined services of circuit-switched and packet-switched systems. For example, system 400 can include a Home Subscriber Server (HSS), a tElephone NUmber Mapping (ENUM) server, and other network elements of an IMS network which can establish communications between IMS-compliant communication devices (CDs), Public Switched Telephone Network (PSTN) CDs, and combinations thereof by way of a Media Gateway Control Function (MGCF) coupled to a PSTN network. Various other devices can be utilized in an IMS network including a Proxy Call Session Control Function (P-CSCF) which communicates with an interrogating CSCF (I-CSCF), which in turn, communicates with a Serving CSCF (S-CSCF) to register the CDs with the HSS. In an IMS network, application servers can be used for performing various functions including originating call feature treatment functions on the calling party number received by the originating S-CSCF in the SIP INVITE message. Cellular phones supporting LTE can support packet-switched voice and packet-switched data communications and thus may operate as IMS-compliant mobile devices. In this embodiment, the cellular base station 717 may communicate directly with the IMS network via the P-CSCF.

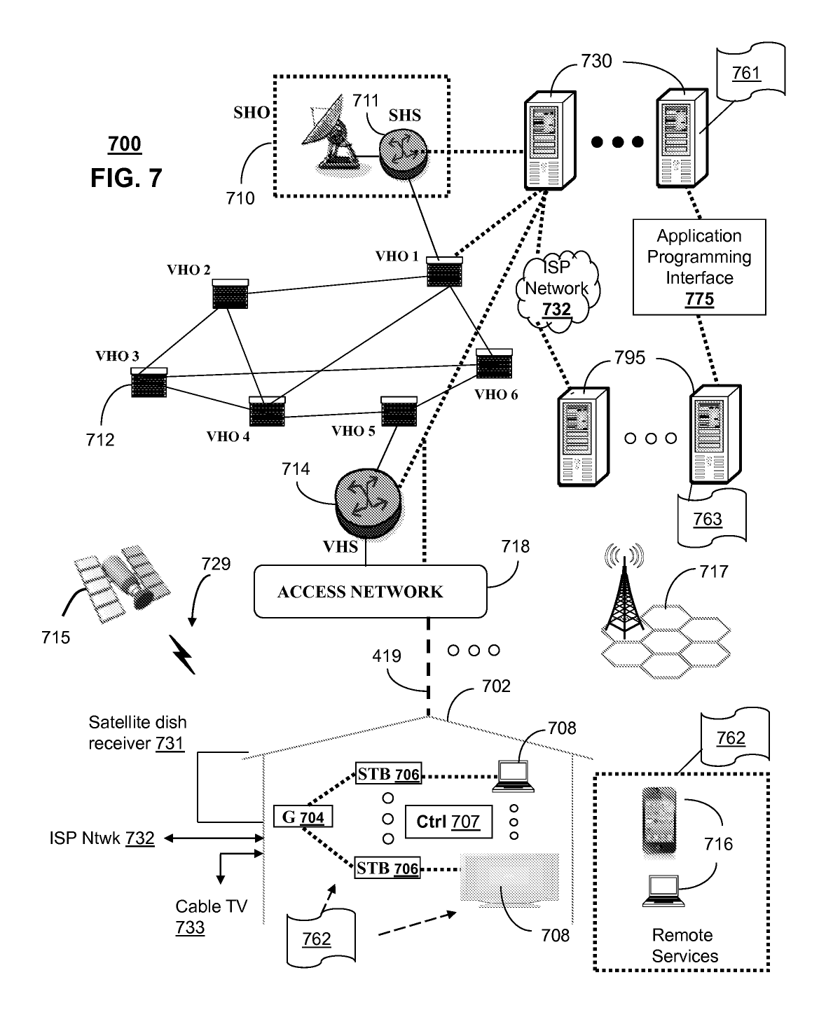

FIG. 8 depicts an illustrative embodiment of a web portal 802 which can be hosted by server applications operating from the computing devices 730 of the communication system 700 illustrated in FIG. 7. The web portal 802 can be used for managing services of communication systems 700. A web page of the web portal 802 can be accessed by a Uniform Resource Locator (URL) with an Internet browser such as Microsoft's Internet Explorer™, Mozilla's Firefox™, Apple's Safari™, or Google's Chrome™ using an Internet-capable communication device such as those described in FIG. 7. The web portal 802 can be configured, for example, to access a media processor 706 and services managed thereby such as a Digital Video Recorder (DVR), a Video on Demand (VoD) catalog, an Electronic Programming Guide (EPG), or a personal catalog (such as personal videos, pictures, audio recordings, etc.) stored at the media processor 706. The web portal 802 can also be used for provisioning IMS services described earlier, provisioning Internet services, provisioning cellular phone services, and so on.

The web portal 802 can further be utilized to manage and provision software applications 761-763 to adapt these applications as may be desired by subscribers and service providers of communication system 700. The web portal 802 can be utilized by end user devices having clients 110 (FIGS. 1-2 and 4-6) for providing various information to be utilized in conjunction with the virtual assistant, such as providing user feedback (or adjusting user feedback) for previously received answers from expert devices 195, such as where a user subsequently determines that an answer if incorrect but has already provided positive feedback for the incorrect answer. The web portal can also be utilized by the expert devices 195 and 795, such as accessing the API specification so that compliant or conforming answers can be generated and provided to the dialog federator 125 via the API 150.

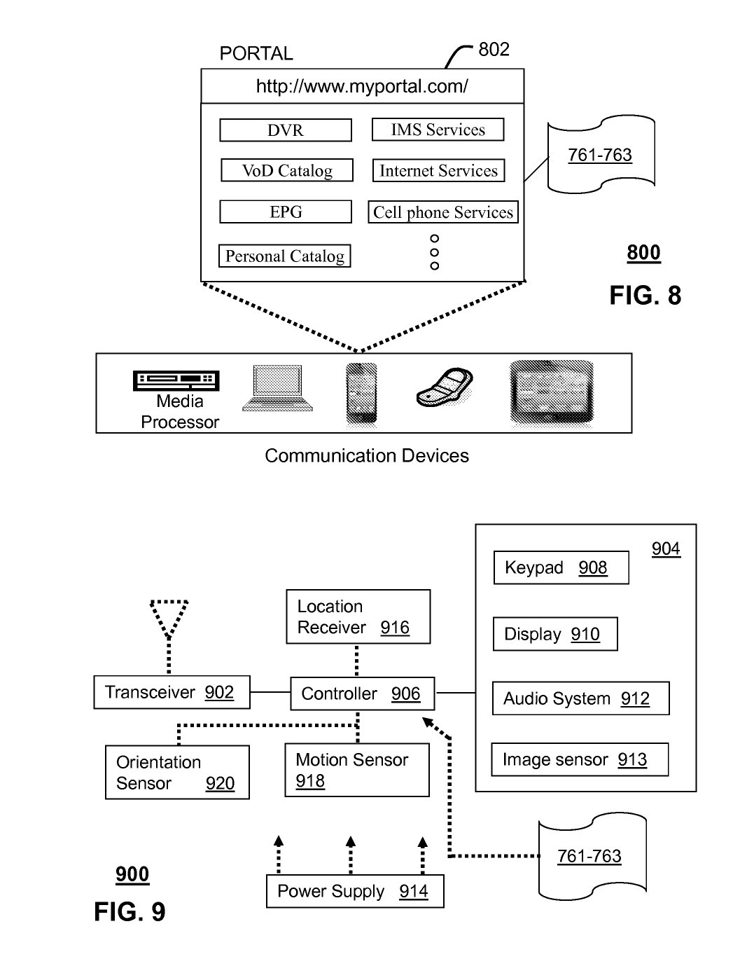

FIG. 9 depicts an illustrative embodiment of a communication device 900. Communication device 900 can serve in whole or in part as an illustrative embodiment of the devices depicted in FIGS. 1-2 and 4-7. Communication device 700 can enable the providing of an API that lets vendor devices (experts) attach their own software modules which each implement one or more features of a virtual assistant. Each expert can provide one or more features and can connect to a dialog federator via the AP). The communication device 900 can be a dialog federator deployed into service by a sponsor such as a service provider, which communicates with the user and is supported by one or more of the experts. The communication device 900 can be an end user device implementing client 110, as described with respect to FIGS. 1-7, to enable transmitting requests, presenting multiple bids that were selectively chosen from among multiple experts, and providing user feedback to the bids.

To enable these features, communication device 900 can comprise a wireline and/or wireless transceiver 902 (herein transceiver 902), a user interface (UI) 904, a power supply 914, a location receiver 916, a motion sensor 918, an orientation sensor 920, and a controller 906 for managing operations thereof. The transceiver 902 can support short-range or long-range wireless access technologies such as Bluetooth, ZigBee, WiFi, DECT, or cellular communication technologies, just to mention a few. Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 902 can also be adapted to support circuit-switched wireline access technologies (such as PSTN), packet-switched wireline access technologies (such as TCP/IP, VoIP, etc.), and combinations thereof.

The UI 904 can include a depressible or touch-sensitive keypad 908 with a navigation mechanism such as a roller ball, a joystick, a mouse, or a navigation disk for manipulating operations of the communication device 900. The keypad 908 can be an integral part of a housing assembly of the communication device 900 or an independent device operably coupled thereto by a tethered wireline interface (such as a USB cable) or a wireless interface supporting for example Bluetooth. The keypad 908 can represent a numeric keypad commonly used by phones, and/or a QWERTY keypad with alphanumeric keys. The UI 904 can further include a display 910 such as monochrome or color LCD (Liquid Crystal Display), OLED (Organic Light Emitting Diode) or other suitable display technology for conveying images to an end user of the communication device 900. In an embodiment where the display 910 is touch-sensitive, a portion or all of the keypad 908 can be presented by way of the display 910 with navigation features.

The display 910 can use touch screen technology to also serve as a user interface for detecting user input. As a touch screen display, the communication device 900 can be adapted to present a user interface with graphical user interface (GUI) elements that can be selected by a user with a touch of a finger. The touch screen display 910 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 910 can be an integral part of the housing assembly of the communication device 700 or an independent device communicatively coupled thereto by a tethered wireline interface (such as a cable) or a wireless interface.

The UI 904 can also include an audio system 912 that utilizes audio technology for conveying low volume audio (such as audio heard in proximity of a human ear) and high volume audio (such as speakerphone for hands free operation). The audio system 912 can further include a microphone for receiving audible signals of an end user. The audio system 912 can also be used for voice recognition applications. The UI 904 can further include an image sensor 913 such as a charged coupled device (CCD) camera for capturing still or moving images.

The power supply 914 can utilize common power management technologies such as replaceable and rechargeable batteries, supply regulation technologies, and/or charging system technologies for supplying energy to the components of the communication device 900 to facilitate long-range or short-range portable applications. Alternatively, or in combination, the charging system can utilize external power sources such as DC power supplied over a physical interface such as a USB port or other suitable tethering technologies.

The location receiver 916 can utilize location technology such as a global positioning system (GPS) receiver capable of assisted GPS for identifying a location of the communication device 900 based on signals generated by a constellation of GPS satellites, which can be used for facilitating location services such as navigation. The motion sensor 918 can utilize motion sensing technology such as an accelerometer, a gyroscope, or other suitable motion sensing technology to detect motion of the communication device 900 in three-dimensional space. The orientation sensor 920 can utilize orientation sensing technology such as a magnetometer to detect the orientation of the communication device 900 (north, south, west, and east, as well as combined orientations in degrees, minutes, or other suitable orientation metrics).

The communication device 900 can use the transceiver 902 to also determine a proximity to a cellular, WiFi, Bluetooth, or other wireless access points by sensing techniques such as utilizing a received signal strength indicator (RSSI) and/or signal time of arrival (TOA) or time of flight (TOF) measurements. The controller 906 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 900.

Other components not shown in FIG. 9 can be used in one or more embodiments of the subject disclosure. For instance, the communication device 900 can include a reset button (not shown). The reset button can be used to reset the controller 906 of the communication device 900. In yet another embodiment, the communication device 900 can also include a factory default setting button positioned, for example, below a small hole in a housing assembly of the communication device 900 to force the communication device 900 to re-establish factory settings. In this embodiment, a user can use a protruding object such as a pen or paper clip tip to reach into the hole and depress the default setting button. The communication device 900 can also include a slot for adding or removing an identity module such as a Subscriber Identity Module (SIM) card. SIM cards can be used for identifying subscriber services, executing programs, storing subscriber data, and so forth.

The communication device 900 as described herein can operate with more or less of the circuit components shown in FIG. 9. These variant embodiments can be used in one or more embodiments of the subject disclosure.

The communication device 900 can be adapted to perform the functions (e.g., via the client 110, the dialog federator 125 and/or the API 150) of the media processor 706, the media devices 708, and/or the portable communication devices 716 of FIG. 7, as well as the IMS CDs and PSTN CDs of an IMS network. It will be appreciated that the communication device 900 can also represent other devices that can operate in communication system 700 of FIG. 7 such as a gaming console and a media player. The controller 906 can be adapted in various embodiments to perform the functions 761-763.

Upon reviewing the aforementioned embodiments, it would be evident to an artisan with ordinary skill in the art that said embodiments can be modified, reduced, or enhanced without departing from the scope of the claims described below. For example, rather than the dialog federator 125 providing a group of separate bids to the client 110 for presentation, the dialog federator and/or the client can combine two or more of the bids and present an adjusted bid based on the combination. For example, a first client 175 may provide the dialog federator 125 with a map showing traffic patterns on the highway a second expert may provide the dialog federator with a graphical representation of weather conditions on the highway. In this example, the client 110 may have generated a request for road conditions associated with a particular highway. The dialog federator 175 can compare the two bids (i.e., the traffic map and the weather map) and can combine the information such as adjusting formats so that sizes match up or otherwise align and then providing one map as an overlay onto the other map. The combined weather and traffic map of the highway can then be provided to the client 110 for presentation. In one embodiment, the comparison and combining of the answers can be performed by the client 110. Other embodiments can be used in the subject disclosure.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

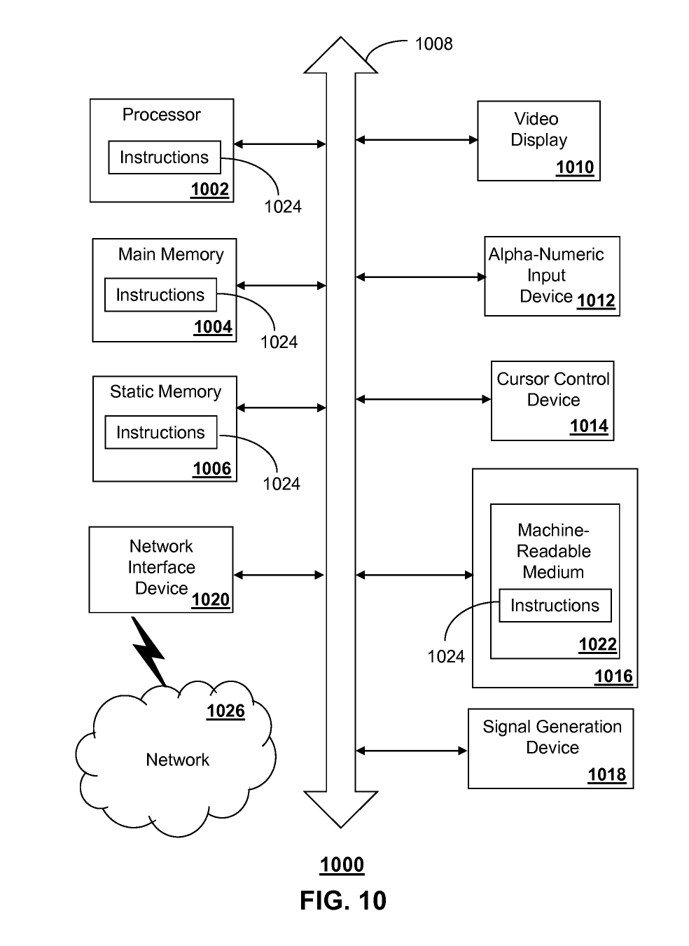

FIG. 10 depicts an exemplary diagrammatic representation of a machine in the form of a computer system 1000 within which a set of instructions, when executed, may cause the machine to perform any one or more of the methods described above, including generating requests, generating expert invites, selecting experts from among a group of experts based on various information including user feedback, generating bids or answers based on the requests, performing a bid selection from multiple expert devices based on feedback including user feedback and/or presenting one or more bids responsive to the request at an end user device. One or more instances of the machine can operate, for example, as the client 110, the dialog federator 125, the API 150, the expert devices 175, the media processor 706, the media device 708, the mobile device 716, the server 730, the expert devices 795 and/or other devices of FIGS. 1-2 and 4-7. In some embodiments, the machine may be connected (e.g., using a network 1026) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 1000 may include a processor (or controller) 1002 (e.g., a central processing unit (CPU), a graphics processing unit (GPU, or both), a main memory 1004 and a static memory 1006, which communicate with each other via a bus 1008. The computer system 1000 may further include a display unit 1010 (e.g., a liquid crystal display (LCD), a flat panel, or a solid state display. The computer system 1000 may include an input device 1012 (e.g., a keyboard), a cursor control device 1014 (e.g., a mouse), a disk drive unit 1016, a signal generation device 1018 (e.g., a speaker or remote control) and a network interface device 1020. In distributed environments, the embodiments described in the subject disclosure can be adapted to utilize multiple display units 1010 controlled by two or more computer systems 1000. In this configuration, presentations described by the subject disclosure may in part be shown in a first of the display units 1010, while the remaining portion is presented in a second of the display units 1010.

The disk drive unit 1016 may include a tangible computer-readable storage medium 1022 on which is stored one or more sets of instructions (e.g., software 1024) embodying any one or more of the methods or functions described herein, including those methods illustrated above. The instructions 1024 may also reside, completely or at least partially, within the main memory 1004, the static memory 1006, and/or within the processor 1002 during execution thereof by the computer system 1000. The main memory 1004 and the processor 1002 also may constitute tangible computer-readable storage media.

Dedicated hardware implementations including, but not limited to, application specific integrated circuits, programmable logic arrays and other hardware devices that can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable array. Furthermore, software implementations (e.g., software programs, instructions, etc.) can include, but not limited to, distributed processing or component/object distributed processing, parallel processing, or virtual machine processing can also be constructed to implement the methods described herein. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 1022 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTML5, HTTP) represent examples of the state of the art. Such standards are from time-to-time superseded by faster or more efficient equivalents having essentially the same functions. Wireless standards for device detection (e.g., RFID), short-range communications (e.g., Bluetooth, WiFi, Zigbee), and long-range communications (e.g., WiMAX, GSM, CDMA, LTE) can be used by computer system 1000.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, can be used in the subject disclosure.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A server, comprising:
a memory to store instructions; and
a processor coupled to the memory, wherein the processor, responsive to executing the instructions, performs operations comprising:
receiving an information request via a communication session from an end user device, wherein the information request is generated at the end user device;
obtaining session metadata associated with the end user device and associated with a group of content service modules, wherein the session metadata includes a monitored response history of the group of content service modules;
selecting a subset of content service modules from among the group of content service modules based on the session metadata;
providing invite messages to the subset of content service modules by way of an application programming interface, wherein the invite messages are indicative of the information request;
receiving a group of responses from the subset of content service modules responsive to the invite messages by way of the application programming interface;
obtaining feedback information associated with at least some of the subset of content service modules, wherein the feedback information includes accuracy ratings for past responses provided by the at least some of the subset of content service modules in response to past information requests of other communication sessions; and
selecting a subset of responses from among the group of responses based on the feedback information.

2. The server of claim 1, wherein the operations further comprise:
determining a subject matter associated with the information request;
identifying the group of content service modules from among a plurality of content service modules according to the subject matter; and
providing the subset of responses to the end user device for presentation, wherein the session metadata includes user preferences of the end user device.

3. The server of claim 2, wherein the operations further comprise:
receiving an additional information request via the communication session from the end user device, wherein the additional information request is generated at the end user device;
determining additional subject matter associated with the additional information request;
determining a correlation between the subject matter of the information request and the additional subject matter of the additional information request by comparing the subject matter and the additional subject matter; and
in response to the determining of the correlation, providing an additional invite message indicative of the additional information request to a content server that provided one of the subset of responses to the server.

4. The server of claim 3, wherein the operations further comprise providing another invite message indicative of the additional information request to another content service module that is not among the subset of content service modules.

5. The server of claim 1, wherein the selecting of the subset of responses based on the feedback information includes selecting the subset of responses that correspond with target content service modules from among the subset of content service modules, wherein a corresponding accuracy rating from among the accuracy ratings for each of the target content service modules satisfies an accuracy rating threshold.

6. The server of claim 1, wherein the operations further comprise:
storing registry data associated with the end user device and the communication session; and
providing the subset of content service modules with access to the registry data by way of the application programming interface.

7. The server of claim 1, wherein the operations further comprise providing format criteria to the subset of content service modules, wherein the group of responses from the subset of content service modules are formatted according to the format criteria.

8. The server of claim 1, wherein the information request includes an audio signal, and wherein the operations further comprise:
converting the audio signal to text to generate a text information request; and
parsing the text information request to determine the subject matter associated with the information request.

9. The server of claim 1, wherein the operations further comprise:
generating an adjusted response based on the subset of responses; and
providing the adjusted response to the end user device for presentation.

10. The server of claim 1, wherein the operations further comprise:
receiving user feedback from the end user device, wherein the user feedback is associated with a presentation by the end user device of a presented response from among the subset of responses;
indexing the user feedback to a target content service module from among the subset of content service modules that provided the presented response to generate indexed user feedback; and
adjusting the feedback information based on the indexed user feedback.

11. The server of claim 2, wherein the operations further comprise:
identifying an unrated content service module from among the plurality of content service modules according to the subject matter, wherein user feedback data associated with the unrated content service module is not accessible to the server; and
providing a second invite message to the unrated content service module, wherein the second invite message is indicative of the information request.

12. The server of claim 1, wherein the past information requests are generated at a group of end user devices during the other communication sessions, and wherein at least one of the group of end user devices is not associated with the end user device.

13. The server of claim 1, wherein the operations further comprise:
storing registry data associated with the end user device and the communication session;
identifying a classification for a first content service module of the subset of content service modules; and
providing the first content service module with access to a subset of the registry data according to the classification by way of the application programming interface.

14. A method comprising:
receiving, by a system including a processor, an information request via a communication session from an end user device, wherein the information request is generated at the end user device;
obtaining feedback information associated with a group of content service modules, wherein the feedback information includes accuracy ratings for past responses provided by the group of content service modules responsive to past information requests of other communication sessions;
selecting a subset of content service modules from among the group of content service modules based on the feedback information;
providing invite messages to the subset of content service modules by way of an application programming interface, wherein the invite messages are indicative of the information request;
receiving a group of responses from the subset of content service modules responsive to the invite messages by way of the application programming interface; and
selecting a subset of responses from among the group of responses based on the feedback information.

15. The method of claim 14, wherein the system performs the obtaining of the feedback information, the selecting of the subset of content service modules, the providing of the invite messages, the receiving of the group of responses and the selecting of the subset of responses.

16. The method of claim 14, further comprising:
determining subject matter associated with the information request; and
identifying the group of content service modules from among a plurality of content service modules according to the subject matter.

17. The method of claim 14, further comprising:
storing registry data associated with the end user device and the communication session;
identifying a classification for a first content service module of the subset of content service modules; and
providing the first content service module with access to a subset of the registry data according to the classification by way of the application programming interface.

18. The method of claim 14, wherein the past information requests are generated at a group of end user devices during the other communication sessions, and wherein at least some of the group of end user devices are not associated with the end user device.

19. A computer-readable storage device, comprising computer instructions which, responsive to being executed by a processor of an end user device, cause the processor to perform operations comprising:
generating an information request based on user input;
providing the information request via a communication session to a server to cause the server to obtain a subset of responses selected from among a group of responses to the information request, wherein the group of responses are generated by a subset of content service modules selected from among a group of content service modules based on feedback information that includes accuracy ratings for past responses provided by the group of content service modules in response to past information requests of other communication sessions;
receiving the subset of responses from the server;
presenting the subset of responses;
generating user feedback based on additional user input, wherein the user feedback is associated with the presenting of the subset of responses; and
providing the user feedback to the server to cause the server to adjust the feedback information based on the user feedback.

20. The computer-readable storage medium of claim 19, wherein the presenting of the subset of responses includes presenting each of the subset of responses in a separate frame on a display of the end user device.
